(19) United States
(12) Patent Application Publication
(10) Pub. No.: US 2023/0141440 A1
(43) Pub. Date: May 11, 2023

(54) INDICATION OF INTRA-UE MULTIPLEXING OR INTRA-UE CANCELLATION

(71) Applicant: QUALCOMM Incorporated, San Diego, CA (US)

(72) Inventors: Wei YANG, San Diego, CA (US); Yi HUANG, San Diego, CA (US); Seyedkianoush HOSSEINI, San Diego, CA (US); Peter GAAL, San Diego, CA (US); Juan MONTOJO, San Diego, CA (US)

(21) Appl. No.: 17/934,049

(22) Filed: Sep. 21, 2022

Related U.S. Application Data
(60) Provisional application No. 63/263,663, filed on Nov. 5, 2021.

(51) Int. Cl. H04L 5/00; H04W 72/10; H04W 72/04

(52) U.S. Cl. CPC H04L 5/0094; H04L 5/0007; H04W 72/10; H04W 72/0413; H04W 72/0446

(57) ABSTRACT

A UE receives radio resource control (RRC) message indicating a semi-static configuration for the UE for one of: intra-UE prioritization for overlapping uplink channels of different priorities or intra-UE multiplexing for the overlapping uplink channels of the different priorities. The UE determines between the intra-UE prioritization or the intra-UE multiplexing for a set of overlapping uplink channels of the different priorities based, at least in part, on the RRC message and transmits an uplink transmission including one or more of the set of overlapping uplink channels based, at least in part, on the semi-static configuration in the RRC message.

### CROSS REFERENCE TO RELATED APPLICATION(S)

This application claims the benefit of and priority to U.S. Provisional Application Serial No. 63/263,663, entitled “Dynamic Indication of Intra-UE Multiplexing or Intra-UE Cancellation” and filed on Nov. 5, 2021, which is expressly incorporated by reference herein in its entirety.

### TECHNICAL FIELD

The present disclosure relates generally to communication systems, and more particularly, to wireless communication including overlapping uplink channels.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus receives radio resource control (RRC) message indicating a semi-static configuration for the UE for one of: for intra-UE prioritization for overlapping uplink channels of different priorities or intra-UE multiplexing for the overlapping uplink channels of the different priorities. The apparatus determines between the intra-UE prioritization or the intra-UE multiplexing for a set of overlapping uplink channels of the different priorities based, at least in part, on the RRC message and transmits an uplink transmission including the set of one or more of the overlapping uplink channels based, at least in part, on the semi-static configuration in the RRC message.

In an aspect of the disclosure, a method, a computer-readable medium, and an apparatus for wireless communication at a base station are provided. The apparatus transmits an RRC message indicating a semi-static configuration for the UE for one of: intra-UE prioritization for overlapping uplink channels of different priorities or intra-UE multiplexing for the overlapping uplink channels of the different priorities. The apparatus receives an uplink transmission including a set of one or more of the overlapping uplink channels based, at least in part, on the semi-static configuration in the RRC message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example diagram showing overlapping uplink channels.

FIG. 5 illustrates an example diagram showing time considerations for multiplexing overlapping uplink channels.

FIG. 6 illustrates an example diagram showing time considerations for multiplexing overlapping uplink channels.

FIGS. 7A and 7B illustrates example aspects of collision resolution of overlapping uplink channels.

FIG. 8 illustrates example aspects of collision resolution of overlapping uplink channels.

FIG. 9 illustrates an example DCI including a dynamic collision resolution indication.

FIG. 10 illustrates example aspects of collision resolution of overlapping uplink channels.

FIG. 11 is an example communication flow that includes example aspects of collision resolution of overlapping uplink channels.

FIG. 12A and FIG. 12B are flowcharts of methods of wireless communication.

FIG. 13 is a diagram illustrating an example of a hardware implementation for an example apparatus or UE.

FIG. 14A and FIG. 14B are flowcharts of methods of wireless communication.

FIG. 15 is a diagram illustrating an example of a hardware implementation for an example apparatus or network entity.

FIG. 16 shows a diagram illustrating an example disaggregated base station architecture.

### DETAILED DESCRIPTION

A UE may exchange wireless traffic with a network, the traffic having different reliability and/or latency requirements. The traffic may be associated with a priority index that indicates whether the traffic is higher priority traffic or lower priority traffic. In some aspects, a UE may drop (e.g., not transmit) a lower priority uplink transmission that collides, e.g., transmission would overlap at least partially in time, with a higher priority uplink transmission. For example, if a higher priority uplink channel would overlap in time with a lower priority uplink channel, the UE may drop the transmission (e.g., not transmit) of the lower priority uplink channel and may transmit the higher priority uplink channel. Dropping transmission of one of the uplink channels may be referred to as intra-UE prioritization and/or intra-UE cancellation, as the UE prioritizes the higher priority uplink channel transmission over the lower priority uplink channel transmission and cancels/drops/does not transmit the lower priority uplink channel transmission. Some dropped or canceled transmissions may lead to inefficient wireless communication with the network. As an example, if a hybrid automatic repeat request (HARQ) acknowledgment (ACK) (HARQ-ACK) from the UE for a correctly received downlink transmission is dropped (e.g., canceled or not transmitted) based on an overlap in time with a higher priority uplink transmission, a base station may not know that the UE received the downlink transmission correctly. The base station may then retransmit the downlink transmission in response to the lack of the HARQ-ACK from the UE even though the UE correctly received the first transmission.

In some aspects, the UE may multiplex uplink transmissions that would overlap in time as a way of resolving collisions between uplink channels. Such multiplexing may be referred to as intra-UE multiplexing (e.g., intra-UE MUX). As presented herein, a network may signal a UE to indicate whether to use intra-UE prioritization (e.g., cancellation) or intra-UE multiplexing to resolve overlapping uplink channel transmissions of different priorities. In some aspects, the indication may include a semi-static indication in which a base station configures the UE through RRC signaling (e.g., an RRC message) with an indication to use intra-UE prioritization (e.g., cancellation) or intra-UE multiplexing when the UE is scheduled for uplink transmissions that overlap in time. A base station may signal the UE with a dynamic indication between intra-UE multiplexing and intra-UE prioritization, which may allow for added flexibility in scheduling uplink communication for the UE. Aspects presented herein provide signaling to the UE indicating different types of collision resolution in a manner that reduces overhead and complexity while providing added flexibility for scheduling and communication between a network and a UE.

detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

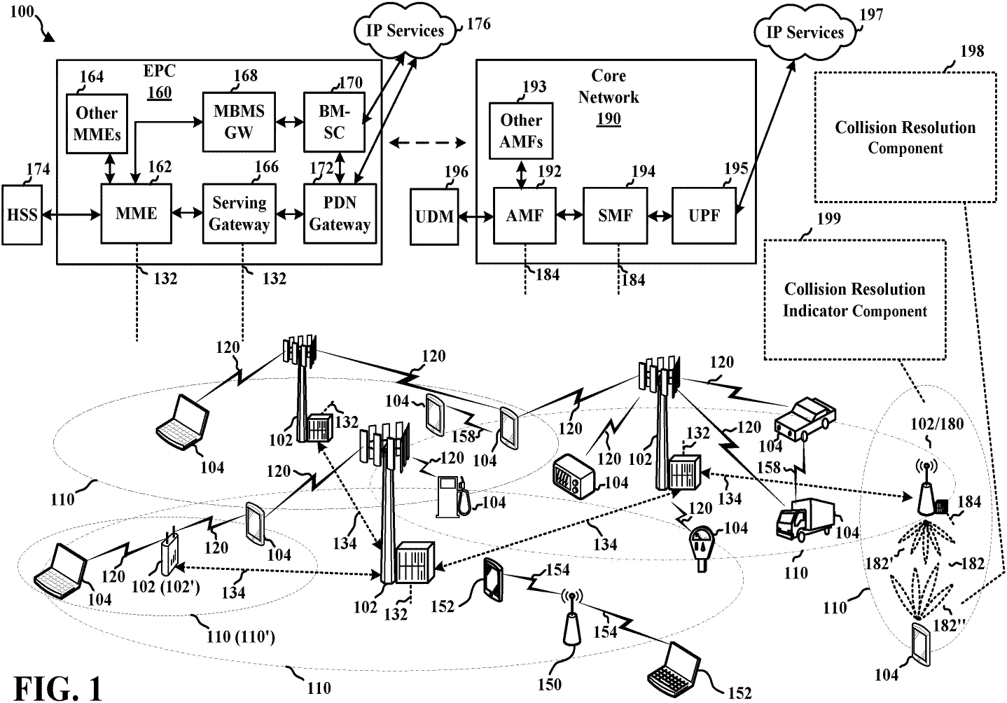

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102 / UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152 / AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz - 7.125 GHz) and FR2 (24.25 GHz - 52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz - 71 GHz), FR4 (71 GHz - 114.25 GHz), and FR5 (114.25 GHz - 300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180 / UE 104 may perform beam training to determine the best receive and transmit directions for each of the base station 180 /UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102/180 can be implemented as an integrated access and backhaul (IAB) node, a relay node, a sidelink node, an aggregated (monolithic) base station with a baseband unit (BBU) (including a central unit (CU) and a distributed unit (DU)) and a radio unit (RU), or as a disaggregated base station including one or more of a CU, a DU, and/or an RU. The set of base stations, which may include disaggregated base stations and/or aggregated base stations, may be referred to as next generation (NG) RAN (NG-RAN). The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a collision resolution component 198 configured to receive a radio resource control (RRC) message indicating a semi-static configuration for the UE for one of: intra-UE prioritization for overlapping uplink channels of different priorities, intra-UE multiplexing for the overlapping uplink channels of different priorities, or a dynamic indication between the intra-UE prioritization and the intra-UE multiplexing for the overlapping uplink channels of different priorities. The collision resolution component 198 may be further configured to determine between the intra-UE prioritization or the intra-UE multiplexing for the overlapping uplink channels of the different priorities based, at least in part, on the RRC message and transmit an uplink transmission including one or more of the overlapping uplink channels based, at least in part, on the configuration in the RRC message. In certain aspects, the base station 180 may include a collision resolution indicator component 199 configured to transmit radio resource control (RRC) message indicating a semi-static configuration for the UE for one of: intra-UE prioritization for overlapping uplink channels of different priorities, intra-UE multiplexing for the overlapping uplink channels of different priorities, or a dynamic indication between the intra-UE prioritization and the intra-UE multiplexing for the overlapping uplink channels of different priorities; and to receive an uplink transmission including one or more of the overlapping uplink channels based, at least in part, on the configuration in the RRC message. Although the following description may be focused on 5G NR, the concepts described herein may be applicable to other similar areas, such as LTE, LTE-A, CDMA, GSM, and other wireless technologies.

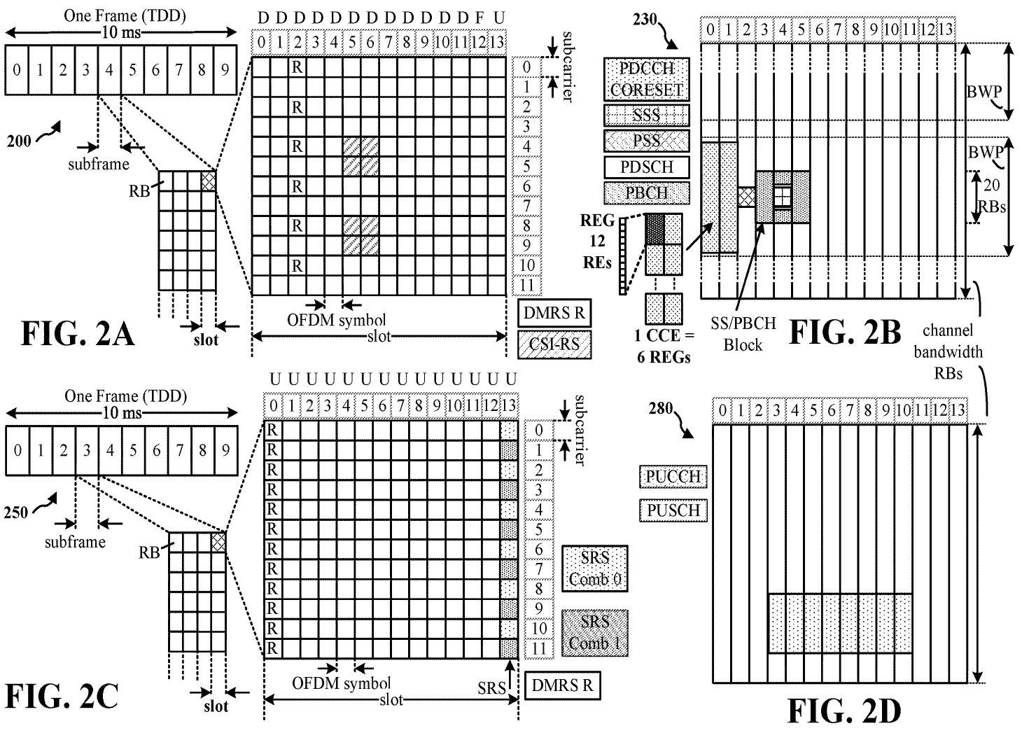

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1

Numerology, SCS, and CP

| µ | SCS Δƒ = 2^{µ} • 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies µ 0 to 4 allow for 1, 2, 4, 8, and 16 slots, respectively, per subframe. For extended CP, the numerology 2 allows for 4 slots per subframe. Accordingly, for normal CP and numerology µ, there are 14 symbols/slot and 2^{µ} slots/subframe. The subcarrier spacing may be equal to 2^{µ} * 15 kHz, where µ is the numerology 0 to 4. As such, the numerology µ=0 has a subcarrier spacing of 15 kHz and the numerology µ=4 has a subcarrier spacing of 240 kHz. The symbol length/duration is inversely related to the subcarrier spacing. FIGS. 2A-2D provide an example of normal CP with 14 symbols per slot and numerology µ=2 with 4 slots per subframe. The slot duration is 0.25 ms, the subcarrier spacing is 60 kHz, and the symbol duration is approximately 16.67 µs . Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ-ACK feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

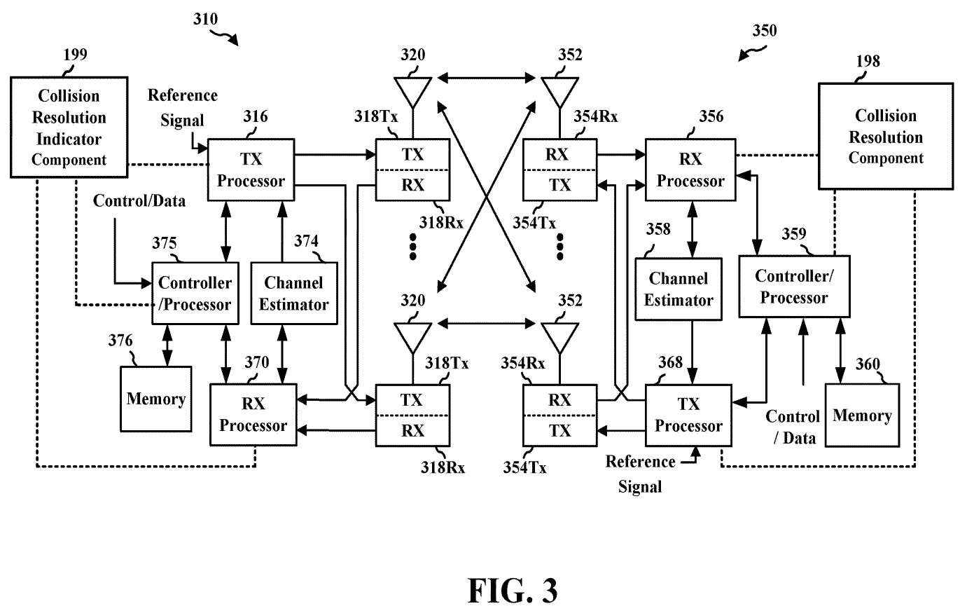

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression /decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

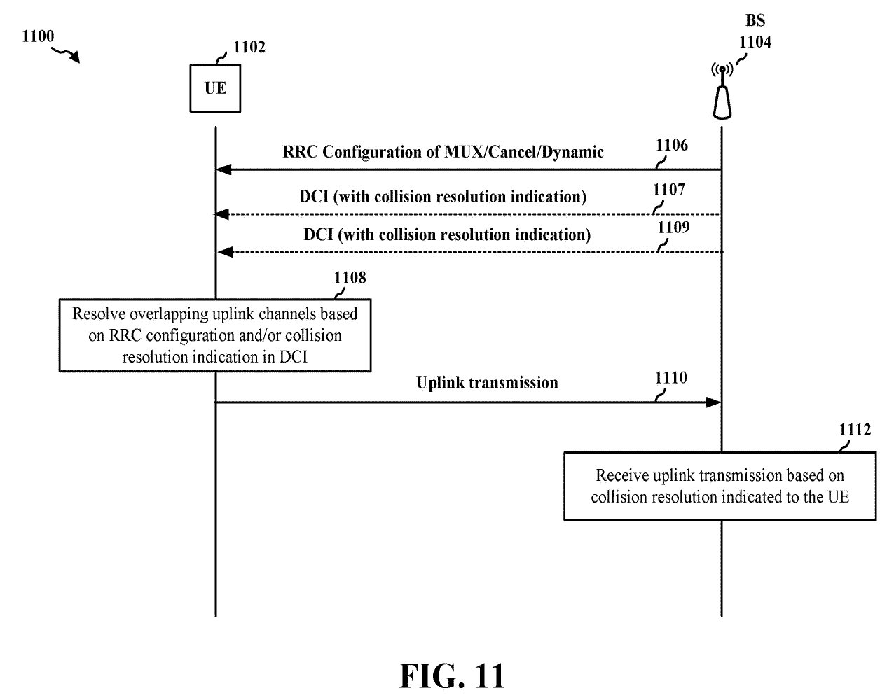

At least one of the TX processor 368, the RX processor 356, and the controller/processor 359 may be configured to perform aspects in connection with the collision resolution component 198 of FIG. 1 and/or aspects in connection with FIGS. 11, 12, and 13.

At least one of the TX processor 316, the RX processor 370, and the controller/processor 375 may be configured to perform aspects in connection with the collision resolution indicator component 199 of FIG. 1 and/or aspects in connection with FIGS. 11, 14, and 15.

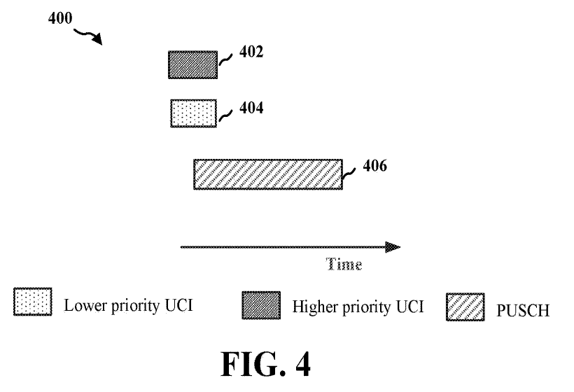

A UE may exchange wireless traffic with a network, the traffic having different reliability and/or latency requirements. The traffic may be associated with a priority index that indicates whether the traffic is higher priority traffic or lower priority traffic. As an example, a priority index 0 may correspond to a lower priority level, and traffic with priority index 0 may be referred to herein as low priority traffic (e.g., low priority (LP) traffic). A priority index 1 may correspond to a higher priority level, and traffic with a priority index 1 may be referred to herein as high priority traffic (e.g., HP traffic). As non-limiting examples to illustrate the concept, lower priority traffic may include eMBB traffic, and higher priority traffic may include URLLC traffic. FIG. 4 illustrates an example time diagram 400 that shows a higher priority UCI transmission 402 that is scheduled at a time that overlaps with a lower priority UCI transmission 404, and which may partially overlap a scheduled PUSCH transmission 406. The overlap in time of the scheduled traffic may be referred to as a collision. As FIG. 4 illustrates an example of overlapping uplink traffic of different priorities, the collision may be referred to as overlapping uplink channels of different priorities.

In some aspects, a UE may drop (e.g., not transmit) a lower priority uplink transmission that collides, e.g., would overlap at least partially in time, with a higher priority uplink transmission. For example, if a higher priority uplink channel would overlap in time with a lower priority uplink channel, the UE may drop the transmission (e.g., not transmit) of the lower priority uplink channel and may transmit the higher priority uplink channel. Dropping transmission of one of the uplink channels may be referred to as intra-UE prioritization and/or intra-UE cancellation, as the UE prioritizes the higher priority uplink channel transmission over the lower priority uplink channel transmission and cancels/drops/does not transmit the lower priority uplink channel transmission. Some dropped or canceled transmissions may lead to inefficient wireless communication with the network. As an example, if a HARQ-ACK from the UE for a correctly received downlink transmission is dropped (e.g., canceled or not transmitted) based on an overlap in time with a higher priority uplink transmission, a base station may not know that the UE received the downlink transmission correctly. The base station may then retransmit the downlink transmission in response to the lack of the HARQ-ACK from the UE even though the UE correctly received the first transmission.

In some aspects, the UE may multiplex uplink transmissions that would overlap in time as a way of resolving collisions between uplink channels. Such multiplexing may be referred to as intra-UE multiplexing (e.g., intra-UE MUX), in some aspects. As an example, resources for UCI may overlap in time with another physical uplink control channel (PUCCH) transmission or physical uplink shared channel (PUSCH) transmission, and the UE may multiplex the UCI with the PUCCH or the PUSCH transmission. A PUSCH or a PUCCH transmission, including repetitions if any, can be of priority index 0 or of priority index 1.

As presented herein, a network may signal a UE to indicate whether to use intra-UE prioritization (e.g., cancellation) or intra-UE multiplexing to resolve overlapping uplink channel transmissions of different priorities. In some aspects, the indication may include a semi-static indication in which a base station configures the UE through RRC signaling (e.g., an RRC message) with an indication to use intra-UE prioritization (e.g., cancellation) or intra-UE multiplexing when the UE is scheduled for uplink transmissions that overlap in time. A base station may signal the UE with a dynamic indication between intra-UE multiplexing and intra-UE prioritization, which may allow for added flexibility in scheduling uplink communication for the UE. The dynamic indication may include additional overhead. Aspects presented herein provide signaling to the UE indicating different types of collision resolution in a manner that reduces overhead and complexity while providing added flexibility.

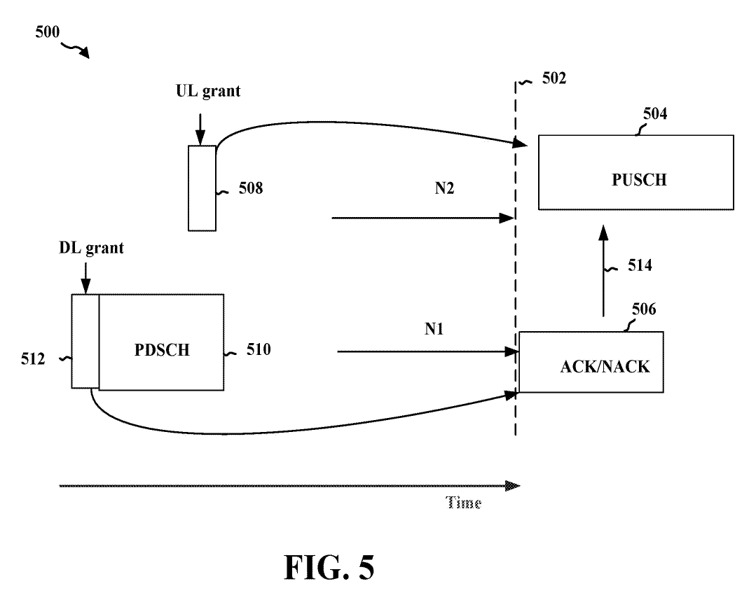

In some aspects, in order to apply intra-UE multiplexing, the HP grant (e.g., for the HP uplink channel) and the LP grant (e.g., for the LP uplink channel) may satisfy a condition of a multiplexing timeline. FIG. 5 illustrates aspects of an example multiplexing timeline 500 for applying intra-UE multiplexing of uplink channel transmissions (e.g. PUSCH 504 and PUCCH with ACK/NACK 506). In some aspects, the condition may involve the UL grant 508 (regardless of priority) arriving at least N2 symbols or T_{proc,2} time prior to an earliest starting channel of the overlapping UL channels (e.g., in FIG. 5 the PUCCH with the ACK/NACK 506 is the earliest starting channel). Additionally, or alternatively, the condition may include the PDSCH 510 (if any and regardless of priority) arriving at least N1 symbols or T_{proc,1} time prior to the earliest starting symbol of the overlapping UL channels. If the timeline based on N1 and/or N2 is not met, the UE may consider intra-UE multiplexing to be an error case and may not multiplex the uplink communication (e.g., the PUSCH 504 and the PUCCH with the ACK/NACK 506). FIG. 5 illustrates an example in which the ACK/NACK 506 is the earliest starting channel of the overlapping uplink channels (e.g., the PUSCH 504 and the PUCCH with the UCI including ACK/NACK 506). FIG. 5 also shows N1 and N2 from the time 502 as which the ACK/NACK 506 would start. As the UL grant 508 of the PUSCH 504 and the DL grant 512 for the PDSCH 510 that leads to the ACK/NACK 506 are both before the timeline based on N1 and N2, the UE may multiplex the ACK/NACK 506 with the PUSCH 504, as shown by the arrow 514, based on intra-UE multiplexing.

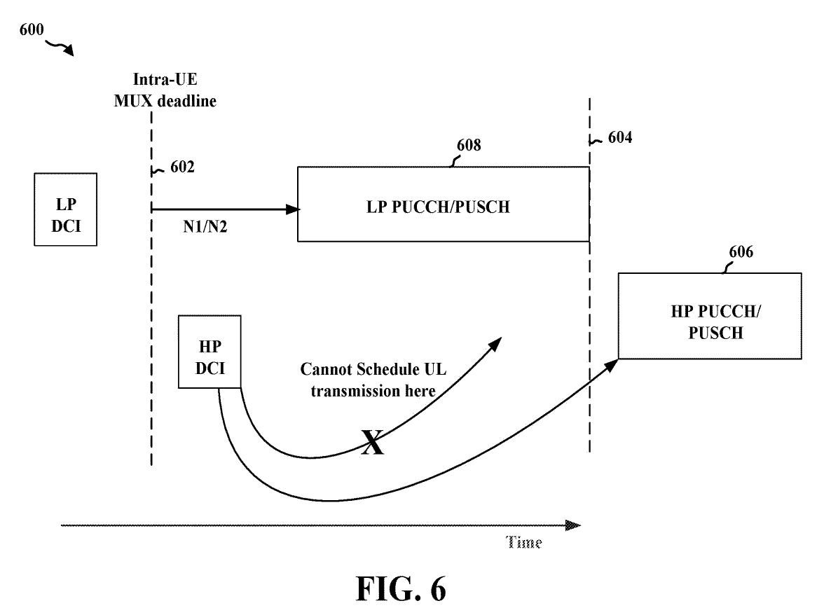

However, if the HP traffic arrives after the multiplexing deadline (e.g., less than N1 and/or N2 from the time 502), and if a base station semi-statically configures the UE to perform intra-UE multiplexing, the base station may not schedule UL transmissions for the UE before the LP channel is finished. FIG. 6 illustrates an example timeline 600 showing the time period from N1 and N2 before the starting time of the LP PUCCH/PUSCH, at 602, until after the end 604 of the LP PUCCH/PUSCH 608 during which the base station may not schedule a HP PUCCH/PUSCH (e.g., so that the UL transmissions are non-overlapping). The delay to schedule the UL transmissions (e.g., HP UL transmissions 606) introduces latency to the HP UL traffic. As an example, the delay in scheduling HP UL traffic, such as URLLC traffic, may lead to latency in such URLLC communication.

As presented herein, the base station may dynamically indicate to the UE to partially cancel the LP PUCCH/PUSCH 608, and to instead transmit the HP PUCCH/PUSCH, e.g., 606, on the symbols that were originally scheduled for the LP channel. By allowing the base station to more dynamically cancel or override uplink communication scheduled for the UE, the HP channel can be scheduled much faster and latency can be reduced. Such a dynamic indication may be referred to herein as a “collision-resolution indication.”

In some aspects, a base station may configure the UE via RRC signaling to use a type of rule, or a type of collision resolution for solving collisions between overlapping uplink channels. FIG. 11 illustrates an example communication flow 1100 in which a base station 1104 transmits RRC signaling 1106 to a UE 1102 that indicates a type of collision resolution for the UE 1102 to use to resolve collisions between overlapping uplink channels. Although aspects are described as being performed by a base station, the aspects may be performed by the base station in aggregated form or by one or more components of a disaggregated base station, such as a CU 1610, DU 1630, and/or RU 1640. As an example, the base station 1104 may configure, or otherwise indicate to, the UE 1102 the type of collision resolution using an RRC parameter which may be called a name such as “CollisionResolution” or by another parameter name. As another example, the parameter may be referred to as “MultiplexingEnabled.” For example, if this RRC parameter is enabled, the RRC message indicates semi-static multiplexing of overlapping uplink channels of different priorities (e.g., multiplexing is enabled for each overlap of channels with different priorities). If the RRC parameter is not enabled, then the RRC message indicates semi-static prioritization/cancellation of overlapping uplink channels of different priorities (e.g., multiplexing is disabled for collision resolution of overlapping uplink channels of different priorities). In some aspects, the RRC parameter may indicate for the UE to follow a dynamic indication. Then, the base station 1104 may dynamically indicate to the UE whether multiplexing is enabled or not. The indication enabling multiplexing may correspond to multiplexing across uplink transmissions with different priorities. For transmissions of the same priority, the multiplexing may already be enabled or may be separately enabled. The RRC signaling may indicate for the UE to apply semi-static intra-UE cancellation (e.g., intra-UE prioritization between overlapping uplink channels of different priorities), semi-static intra-UE multiplexing for overlapping uplink channels of different priorities, or to monitor for dynamic signaling of a collision resolution indication for overlapping uplink channels of different priorities. Table 2 illustrates examples of the types of collision resolution that may be configured for the UE in RRC signaling.

TABLE 2

| | |
|---|---|
| Types of Collision Resolution that May be indicated in RRC configuration | Action to be Applied by UE |
| Semi-static cancellation | Apply intra-UE prioritization/cancellation for overlapping uplink channels |
| Semi-static multiplexing | Apply intra-UE multiplexing for overlapping uplink channels |
| Dynamic | Apply a type of collision resolution indicated in DCI |

If the base station 1104 indicates via the RRC parameter, e.g., at 1106, for semi-static cancellation or semi-static multiplexing, the UE may apply the indicated type of collision resolution for overlapping uplink channel transmissions of different priorities without further dynamic signaling about the type of collision resolution to apply. As an example, DCI scheduling the overlapping uplink channels may not include information about collision resolution.

If RRC signaling indicates for dynamic indication of collision resolution, the UE may further receive a collision resolution indication in additional control signaling such as DCI scheduling one or more of the overlapping uplink transmissions. As an example, the UE may receive DCI format 1_1, DCI format 0_1, DCI format 1_2, or DCI format 0_2 scheduling an uplink channel that will overlap with another uplink channel transmission of a different priority. One or more bits, in at least one of the DCI format 1_1, DCI format 0_1, DCI format 1_2, or DCI format 0_2 that schedule an uplink channel, may indicate the type of collision resolution for the UE to apply for an overlap involving the scheduled uplink channel. In some aspects, the DCI formats 1_1, DCI format 0_1, DCI format 1_2, or DCI format 0_2 may be referred to as non-fallback DCI formats. In some aspects, the non-fallback DCI formats may correspond to a connected state for a UE.

In some aspects, the signaling may indicate (either semi-statically in RRC or dynamically in DCI) whether intra-UE multiplexing is enabled across UCIs of a given UCI type. As an example, the base station 1104 may enable intra-UE multiplexing at the UE 1102 for HARQ-ACK, and/or SR, but not for CSI. Additionally, or alternatively, the base station 1104 may indicate that intra-UE multiplexing is enabled/disabled for multiplexing between HARQ-ACK and PUSCH.

In some aspects, if the RRC signaling, e.g., at 1106, indicates the dynamic type of collision resolution, the non-fallback DCI formats, e.g., each of the non-fallback DCI formats, may contain the collision resolution indication, e.g., one or more bits indicating whether the UE 1102 is to apply intra-UE cancellation/prioritization or intra-UE multiplexing. As an example, the collision resolution indication in DCI 1107 may indicate whether intra-UE multiplexing or cancellation/prioritization (e.g. across different priorities) are enabled or disabled. The fallback DCI formats, e.g., DCI format 0_0 and DCI format 1_0, may not include the collision resolution indication.

In some aspects, if the RRC signaling, e.g., at 1106, indicates the dynamic type of collision resolution, the base station 1104 may further indicate to the UE 1102 the DCI formats, e.g., from the non-fallback DCI formats, that the UE is to expect to receive having the collision resolution indication. The non-indicated DCI formats may not include a collision resolution indication.

For the group of overlapping channels, if at least one of the overlapping uplink channels is an uplink channel that is dynamically scheduled by a DCI format including the dynamic indication, then the UE 1102 may follow the rule indicated in DCI 1107, e.g., a dynamic indication of a type of collision resolution indicated in DCI may override a semi-static configuration indicated in the RRC signaling. As an example, if the RRC signaling indicates semi-static multiplexing, and the DCI includes a collision resolution indication indicating intra-UE cancellation, the UE 1102 may apply the intra-UE cancellation/prioritization for overlapping uplink channels.

If the overlapping channels are either RRC configured, or dynamically scheduled by DCI format(s) that do not have the collision-resolution indication, then the UE 1102 may fall back to intra-UE multiplexing, in some aspects. For example, there may not be a timeline issue for semi-static channels for which the resource allocation may occur well in advance of the overlapping uplink channels.

If the overlapping channels are either RRC configured, or dynamically scheduled by DCI format(s) that do not have the collision-resolution indication, then the UE 1102 falls back to an intra-UE cancellation/prioritization type of collision resolution, in some aspects.

In some aspects, if the overlapping channels are either RRC configured, or dynamically scheduled by DCI format(s) that do not have the collision-resolution indication, and if all high priority (HP) channels are RRC configured, the UE 1102 may apply intra-UE multiplexing. If there is at least one HP channel that is dynamically scheduled by a DCI without a collision resolution indication, the UE 1102 may apply intra-UE cancellation/prioritization.

In some aspects, a rule for handling a collision between overlapping channels that are either RRC configured, or dynamically scheduled by DCI formats that do not include the collision resolution indication, may be indicated by another RRC parameter. In some aspects, an RRC configuration for collision resolution rule (e.g., whether intra-UE multiplexing across different priorities are enabled or not) may be channel specific, e.g., each channel may have a separate indication. Examples of different uplink channels include SR, CSI, HARQ-ACK for Semi Persistent Scheduling (SPS) PDSCH, configured-grant PUSCH, etc. In some aspects, an RRC configuration, e.g., at 1106, for collision resolution rule (e.g., whether intra-UE multiplexing across different priorities are enabled or not) may be UE specific. Once the UE 1102 receives the collision resolution configuration, the UE 1102 may apply the configured type of collision resolution to all overlapping uplink channels. If the RRC configuration, e.g., at 1106, for the collision resolution is channel specific, the indication may be configurable for HP channels, e.g., and not LP channels. If the RRC configuration for the collision resolution is channel specific, the indication may be configurable for both HP and LP channels. If the RRC configuration for the collision resolution is channel specific, the indication may be maintained, or expected to be, consistent (e.g., the collision resolution indication being the same) across all HP channels that overlap. If the RRC configuration for the collision resolution is channel specific, the indication may not be consistent across all HP overlapping channels. In some aspects, if at least one HP channel has intra-UE “cancellation” indicated, the UE 1102 may apply intra-UE cancellation for resolving overlapping uplink channels. Otherwise (e.g., if all semi-static indications are for intra-UE “multiplexing”), the UE 1102 may apply intra-UE multiplexing for resolving overlapping uplink channels.

In some aspects, if the UE 1102 identifies a group of overlapping uplink channels, with at least one of the uplink channels scheduled by a DCI format that includes a collision resolution indication, the UE may consider the collision resolution indication indicated in an HP grant scheduling a HP transmission on an uplink channel, e.g., without considering any collision resolution indication in a LP grant scheduling a LP transmission on an uplink channel. In some aspects, collision resolution indications in different HP grants may be expected to be the same. For example, the UE 1102 may not expect multiple HP grants (e.g., in DCI) scheduling overlapping HP transmissions (which may also overlap with one or more LP transmissions) in which the collision resolution indications are not the same. In some aspects, the indications in different grants may not need to be consistent, and overriding may be only one directional (e.g., overriding may occur for one type of collision resolution but not another type).

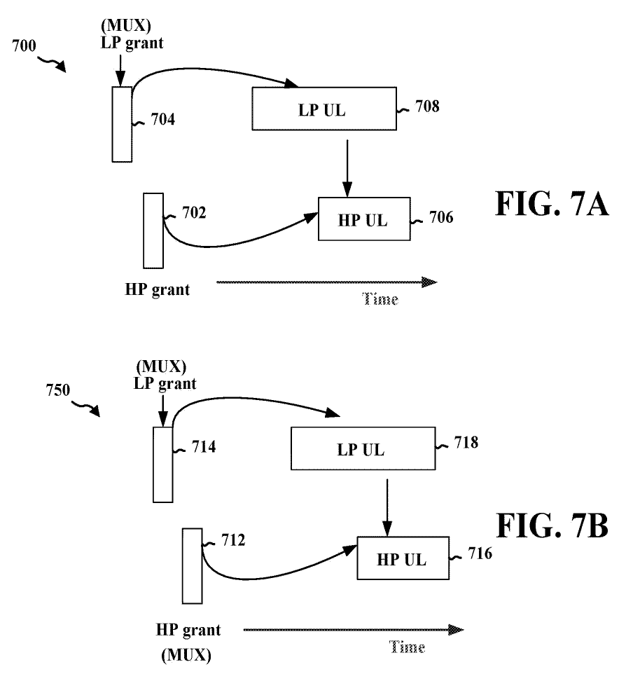

FIG. 7A illustrates an example 700 in which an HP grant 702 scheduling a HP uplink transmission 706 with a dynamic indication for intra-UE multiplexing may be received after an LP grant 704 scheduling an LP uplink transmission 708 and having a prior collision resolution type. The UE 1102 may consider the collision resolution type indicated in the HP grant 702 and ignore the collision resolution type indicated in the LP grant 704, in some aspects. For example, the UE 1102 may apply the type of collision resolution indicated in the HP grant rather than the one indicated in the LP grant.

In some aspects, if the UE 1102 identifies a group of overlapping uplink channels, with at least one of the uplink channels scheduled by a DCI format that includes a collision resolution indication, the UE 1102 may consider the collision resolution indication indicated in both a HP grant scheduling a HP transmission on an uplink channel and LP grant scheduling a LP transmission on an uplink channel. FIG. 7B illustrates an example 750 in which the UE 1102 may receive both an LP grant 714 with a dynamic collision resolution indication (e.g., for intra-UE multiplexing) and an HP grant 712 with a dynamic collision resolution indication (e.g., for intra-UE multiplexing). In some aspects, the collision resolution indications in different grants (both HP and LP) may be expected to be the same. The UE may multiplex the LP uplink transmission 718 scheduled by the LP grant 714 and the HP uplink transmission 716 scheduled by the HP grant 712 based on the collision resolution indication, for example. The base station 1104 may determine the UE’s multiplexing (e.g., intra-UE multiplexing) or cancelation (e.g., intra-UE prioritization) behavior ahead of time in order to allow for the indications in different grants to be the same. By expecting the indications to be the same, the UE may be provided with the information about multiplexing or cancellation earlier in time and allow for the UE 1102 to more easily implement the intended type of contention resolution. In some aspects, the base station 1104 may indicate for the UE to apply intra-UE prioritization (e.g., by setting the collision resolution indicator to “cancel”) in the LP grant, if the base station 1104 does not yet know whether there will be an HP grant arriving later. If the base station 1104 knows in advance that there will be an HP channel to be multiplexed together, then the base station 1104 can preset the indication to “multiplex” (e.g., in the LP grant). In some aspects, the indications in different grants may not be consistent, and overriding of a prior indication by a later indication may be one directional (e.g., overriding may occur for one type of collision resolution but not another type).

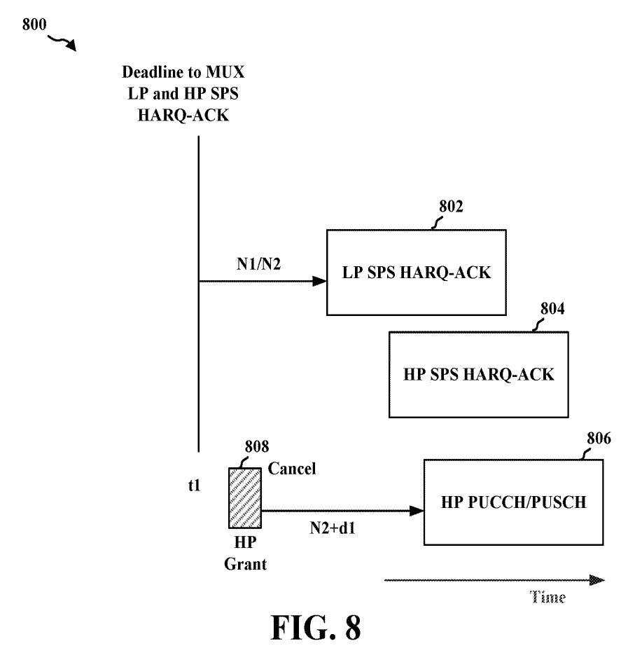

In some aspects, a dynamic indication may not override a semi-static indication. For example, in the scenario of FIG. 8, if there was already an overlap between the HP and LP channel that are both configured channels, then the base station 1104 may not send another dynamic grant to cancel the LP channel. In some aspects, a dynamic indication may override a semi-static indication (a later indication for intra-UE multiplexing may override an earlier indication for intra-UE cancellation). For example, in FIG. 11, if the RRC signaling 1106 indicates for the UE 1102 to use semi-static multiplexing, and the UE 1102 receives a DCI 1107 scheduling an overlapping uplink channel and indicating a collision resolution indication for intra-UE cancellation/prioritization, the dynamic indication in the DCI 1107 may override the semi-static indication. The UE 1102 may apply intra-UE cancellation for the overlapping uplink channels based on the indication in the DCI 1107 instead of the indication in the RRC signaling 1106. In some aspects, the overriding may conditionally occur based on a particular direction: e.g., a change from semi-static multiplexing to an intra-UE cancellation based on a dynamic indication, but may not occur for a change from semi-static cancellation to intra-UE multiplexing based on a dynamic indication.

In some aspects, a dynamic indication may override a previously transmitted dynamic indication. As an example, the UE 1102 may receive a first DCI 1107 with a collision resolution indication for intra-UE multiplexing, and may later receive a DCI 1109 for an overlapping uplink channel, the later DCI 1109 including a collision resolution indication for intra-UE cancellation. The dynamic indication in the later received DCI 1109 may override the earlier received collision resolution indication in the DCI 1107, and the UE 1102 may determine, at 1108, to apply the intra-UE cancellation for the overlapping uplink channels. In some aspects, the overriding may conditionally occur based on a particular direction: e.g., a change from dynamic multiplexing to an intra-UE cancellation based on a later received dynamic indication, but may not occur for a change from semi-static cancellation to intra-UE multiplexing based on a dynamic indication that is later in time.

FIG. 8 illustrates an example time diagram 800 showing that the UE 1102 may have overlapping channels 802 and 804 with a semi-static or dynamic indication to perform intra-UE multiplexing for overlapping channels. Thus, the UE 1102 may multiplex the semi-static HP HARQ-ACK (e.g., 802) with LP PUCCH/PUSCH (e.g., 804) at time t1. In some aspects, the UE 1102 may receive an RRC message, e.g., 1106, to indicate for the UE 1102 to multiplex semi-statically configured channels that overlap. In some aspects, the UE 1102 may determine to multiplex semi-statically configured channels that overlap (e.g., without receiving any indication). An overriding collision resolution indication in DCI 808 (e.g., 1107) (e.g., may lead the UE to de-multiplex the LP/HP PUCCH/PUSCH, and discard the LP UCI. The UE may then multiplex the HP HARQ-ACK (e.g., 802) on the HP PUCCH/PUSCH 806 in order to transmit the uplink transmission 1110. The change in collision resolution types may add complexity for the UE 1102.

In some aspects, the UE 1102 may drop the semi-statically configured LP and HP uplink transmissions (e.g., 802 and 804), and instead transmit the dynamic HP channel (e.g., PUCCH/PUSCH) 806 in the uplink transmission 1110.

If the ending channel (or resulting channel after multiplexing) after semi-static multiplexing is a low priority channel, then the UE 1102 may drop or cancel both semi-static channels (including HP and LP, e.g., 804 and 802). If the resulting channel after the semi-static multiplexing is a high priority channel, then the UE 1102 may not allow overriding of a collision resolution type based on the cancellation indication in the DCI 808. As an example, the UE 1102 may not expect to receive a dynamic indication from the base station to override the collision resolution type from multiplexing to cancellation.

In some aspects, a new timeline, e.g., a different timeline, may be provided for an HP grant, e.g., DCI 1107, with a dynamic collision resolution indication to override the RRC configuration, e.g., at 1106, of a semi-static collision resolution type. As an example, the timeline may indicate for the HP dynamic grant to arrive at least N2+x before the earliest symbol of the final channel (e.g., the channel used to multiplex the semi-static HP and LP channels) in order to demultiplex the semi-static HP and LP channels, and then to multiplex the semi-static HP channel with the dynamic HP channel and drop the LP channel (based on the HP grant indicating cancellation, e.g., where multiplexing across different priorities is not enabled for this group of overlapping channels).

In some aspects, the cancelled semi-static HP UCI may be deferred to a later transmission occasion, e.g., the next transmission occasion rather than being dropped or cancelled. In some aspects, the semi-static LP UCI may be deferred to a later transmission occasion.

For the semi-static enabling/disabling mechanism, in which the collision resolution type is indicated in RRC signaling, e.g., 1106, as either semi-static multiplexing or semi-static cancellation/prioritization, to the base station 1104 may configure an UL/DL DCI having different sizes depending on whether semi-static cancelation or semi-static multiplexing is configured for the collision resolution type. As the UE 1102 knows the collision resolution type, the UE 1102 will know the DCI size based on the semi-static collision resolution type. For example, if the RRC configuration indicates a semi-static cancellation, then DCI 1_1/1_2/0_1/0_2 has a first size. If the RRC configuration indicates semi-static multiplexing, then DCI 1_1/1_2/0_1/0_2 may have a second size, different from the first size. As an example, if intra-UE multiplexing is configured, the DCI may include multiple downlink assignment indexes (DAIs), multiple beta-factor fields, one or more new fields used to indicate parameters associated with intra-UE multiplexing, etc. As an example, the DCI may include two DAIs, two beta factor fields, etc. In contrast, if intra-UE cancellation/prioritization is configured, the DCI may include a single DAI, a single beta factor, and the DCI may not include other fields that are only relevant for intra-UE multiplexing. The UE 1102 may use the anticipated size of the DCI in order to accurately decode the DCI 1107. The semi-static configuration of the collision resolution type enables the UE 1102 to be aware of the DCI size in order to receive the DCI 1107.

If the base station 1104 configures dynamic collision resolution for the UE 1102 in the RRC signaling 1106, the actual collision resolution indication for the UE 1102 to apply for a particular overlap is received in the DCI 1107, and the UE 1102 may not know the collision resolution type, and therefore, the corresponding DCI size, until the collision DCI is received.

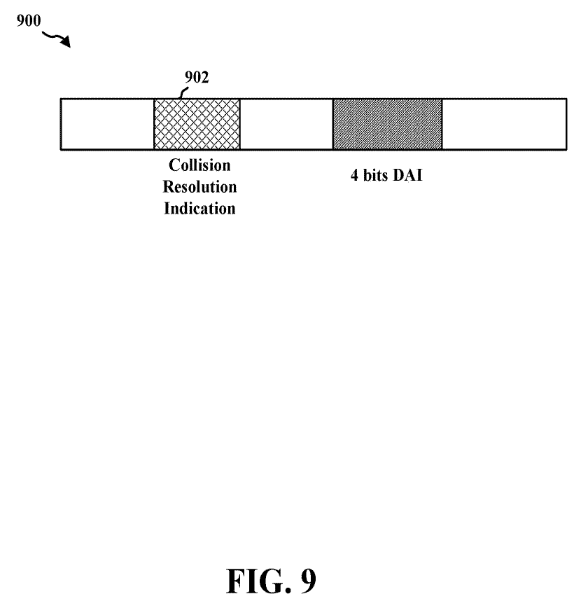

In order to improve the UE’s reception of the DCI 1107, if dynamic collision resolution indication is configured for the UE 1102 (e.g., the RRC signaling indicates “dynamic”), for each field of a DCI format, the UE 1102 may set the bitwidth of the field to be the largest size between a field size used for “intra-UE multiplexing” and a field size used for “intra-UE cancellation.” The base station 1104, and UE 1102, may zero-pad the DCI field having a smaller bitwidth to this larger bitwidth. This allows the UE 1102 to use a common DCI size to receive the DCI 1107 whether it indicates intra-UE multiplexing or intra-UE cancellation as the dynamic collision resolution type. The codepoint of the bitwidth of the DCI 1107 may be interpreted based on the dynamic collision resolution indication field. FIG. 9 illustrates an example DCI 900 that includes a collision resolution indication and 4 bits of DAI. If intra-UE cancellation requires 2 bit DAI, and intra-UE multiplexing requires 4 bit DAI, then the UE 1102 may use the 4 bit for the DAI field in the DCI format that includes the dynamic indication, e.g., as shown in FIG. 9. When the dynamic indication 902 indicates “multiplexing”, then all 4 bits may be used to indicate the DAI. If the dynamic indication 902 indicates “cancellation”, then two bits of the 4 bits may be used to indicate the DAI. In some aspects, the first 2 bits of the 4 bits may be used to indicate the DAI. And the last 2 bits may be set to zero. In some aspects, the last 2 bits of the 4 bits may be used to indicate the DAI rather than the first 2 bits. And the first 2 bits may be set to zero.

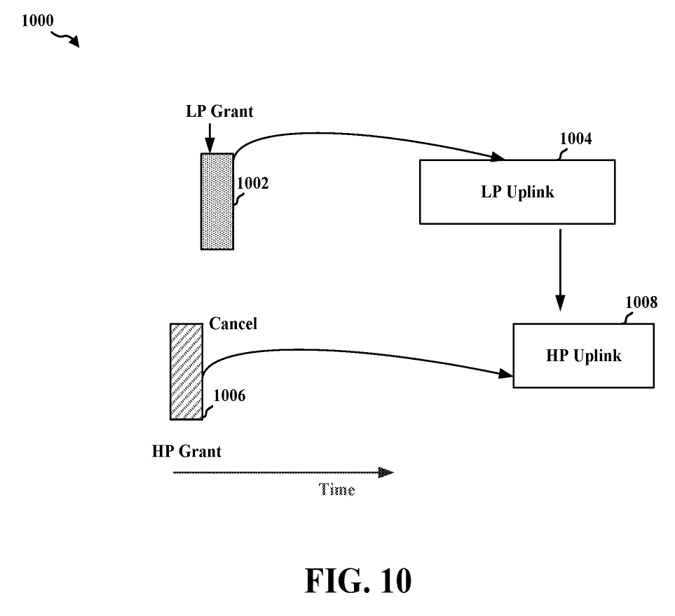

In some aspects, the UE 1102 may not expect to receive an LP grant after an HP grant, where the HP and LP grants schedule corresponding overlapping HP and LP uplink transmissions, and LP or HP DCI indicates “intra-UE cancellation.” In some aspects, the UE 1102 may not expect to receive an LP grant scheduling an LP transmission that overlaps with a semi-statically configured HP channel or a HP channel scheduled by a DCI format that does not include the dynamic indication field, where the semi-static indication of collision rules for the HP channel indicates “cancellation” (or equivalently, “not multiplex”). FIG. 10 illustrates a time diagram 1000 in which the UE 1102 may receive a LP grant 1002 scheduling a LP UL channel 1004 after receiving HP DCI 1006 scheduling a HP channel 1008 and indicating intra-UE cancellation/prioritization as the collision resolution type. The UE 1102 may consider the reception of the LP grant after the HP grant to be an error. In some aspects, the base station 1104 may refrain from sending a LP grant after a HP grant, where the HP and LP grants schedule corresponding overlapping HP and LP uplink transmissions, and LP or HP DCI indicates “intra-UE cancellation.” If the base station 1104 knows that the LP UL channel will be cancelled (at the time when the LP grant is sent), the base station may skip sending the LP grant.

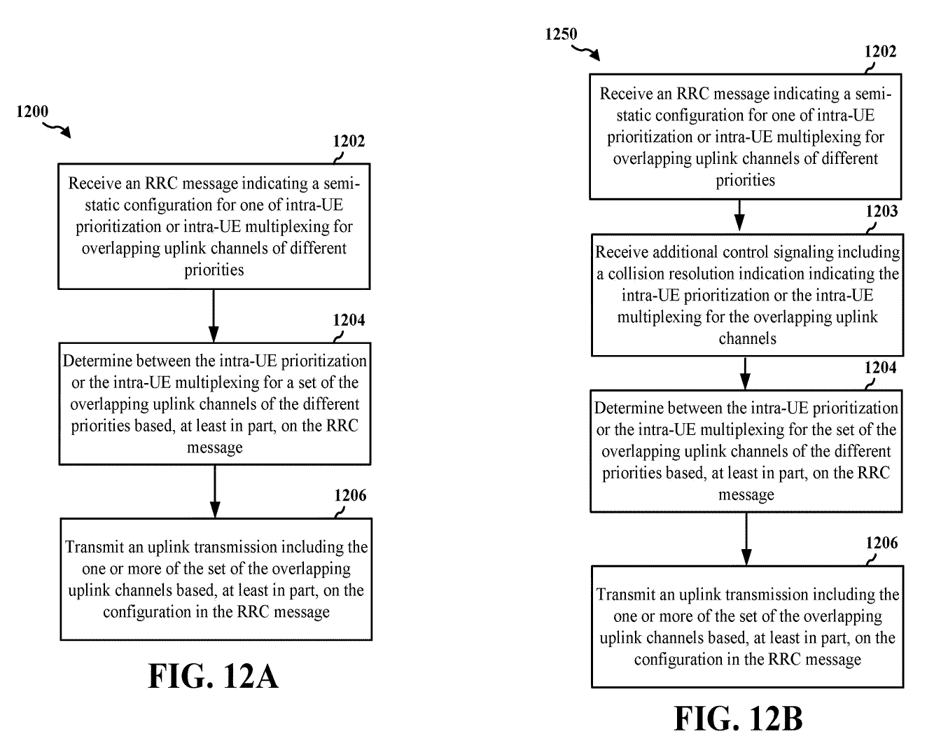

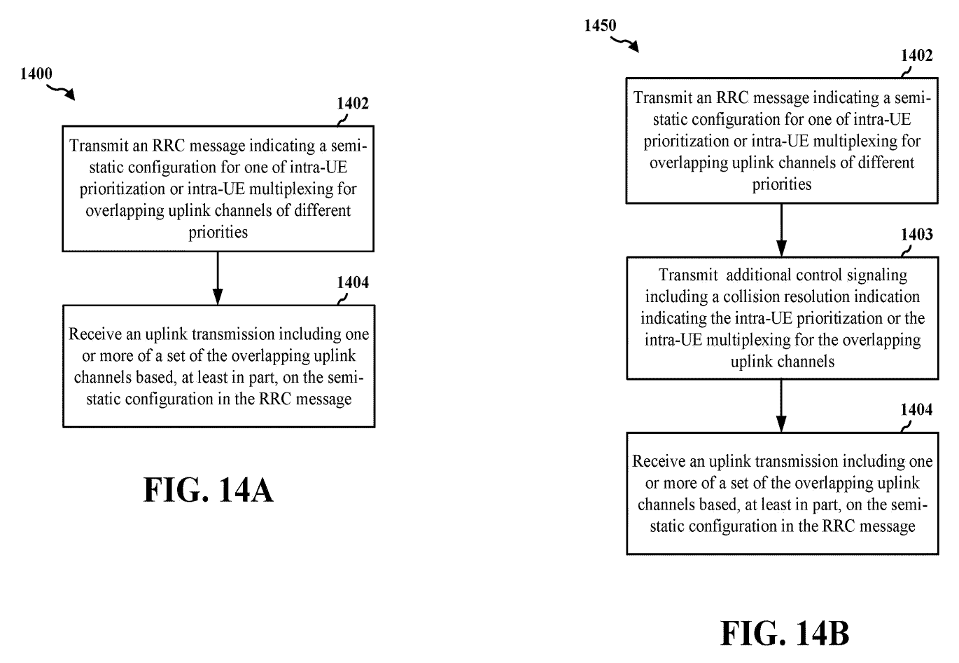

As described in the present application, the base station 1104 may transmit an RRC configuration, at 1106, to the UE 1102 indicating for the UE to apply one of semi-static intra-UE multiplexing, semi-static intra-UE cancellation, or a dynamic collision resolution type. In some aspects, the base station 1104 may then provide DCI 1107 that includes a dynamic indication of the collision resolution type. As illustrated at 1108, the UE 1102 may resolve overlapping uplink channels based on the RRC configuration and/or the dynamic collision resolution indication in the DCI 1107. For example, the UE 1102 may determine between intra-UE prioritization or intra-UE multiplexing for overlapping uplink channels of different priorities based on the RRC signaling 1106, and in some aspects the DCI 1107. The resolution applied at 1108 may include any of the aspects described herein, e.g., including any of the aspects described in connection with FIGS. 4-10, 12, or 14. At 1110, the UE 1102 may transmit an uplink transmission with the collision between overlapping uplink channels resolved in the manner determined at 1108. The base station 1104 may receive the uplink transmission, at 1112, based on the type of collision resolution that the base station 1104 indicated to the UE 1102 in the RRC signaling 1106 and/or DCI 1107. The UE 1102 may further perform any of the additional aspects described in connection with the flowcharts in FIGS. 12A or 12B. The base station 1104 may further perform any of the additional aspects described in connection with the flowcharts in FIGS. 14A or 14B.

FIG. 12A is a flowchart 1200 of a method of wireless communication. The method may be performed by a UE (e.g., the UE 104, 350, 1102; the apparatus 1304). The method may enable a UE to determine between intra-UE prioritization and intra-UE multiplexing of overlapping uplink channels having different priorities. The method may improve communication between the network and the UE by reducing latency and improving collision resolution for overlapping uplink channels of different priorities.

At 1202, the UE receives an RRC message indicating a semi-static configuration for the UE for one of: intra-UE prioritization for overlapping uplink channels of different priorities or intra-UE multiplexing for the overlapping uplink channels of the different priorities. In some aspects, the RRC message may indicate the semi-static configuration for a dynamic indication between the intra-UE prioritization and the intra-UE multiplexing for the overlapping uplink channels of the different priorities. FIG. 11 illustrates an example of an RRC message indicating the semi-static configuration. In some aspects, the RRC message indicates the semi-static configuration for the UE for the intra-UE prioritization for the overlapping uplink channels of the different priorities or the intra-UE multiplexing for the overlapping uplink channels of the different priorities based on an RRC parameter indicating the intra-UE multiplexing being enabled or not enabled.

At 1204, the UE determines between the intra-UE prioritization or the intra-UE multiplexing for a set of the overlapping uplink channels of the different priorities based, at least in part, on the RRC message. In some aspects, the determination may be further based on additional control signaling, such as an indicating in DCI, e.g., if the RRC message indicates the dynamic indication between the intra-UE prioritization and the intra-UE multiplexing. FIG. 11 illustrates an example of the UE 1102 determining the manner in which to resolve overlapping uplink channels of different priorities, at 1108.

At 1206, the UE transmits an uplink transmission including one or more of the set of the overlapping uplink channels based, at least in part, on the semi-static configuration in the RRC message. FIG. 11 illustrates an example of the UE 1102 transmitting an uplink transmission 1110 based, at least in part, on the semi-static configuration indicating in the RRC message at 1106.

In some aspects, the RRC message may indicate the semi-static configuration for the intra-UE prioritization for the overlapping uplink channels, and the transmitting the uplink transmission, at 1206, may include transmitting a higher priority channel and dropping transmission of a lower priority from the overlapping uplink channels based on the semi-static configuration. In some aspects, “dropping” such as dropping an overlapping uplink channel, or dropping from an overlapping uplink channel may be used to refer to dropping the transmission that overlaps, e.g., rather than dropping an entire channel.

In some aspects, the RRC message may indicate the semi-static configuration for the intra-UE multiplexing for the overlapping uplink channels of the different priorities, and the transmitting the uplink transmission, at 1206, may include multiplexing a higher priority channel and a lower priority from the overlapping uplink channels based on the semi-static configuration.

In some aspects, the RRC message may indicate the semi-static configuration for the dynamic indication between the intra-UE prioritization and the intra-UE multiplexing for the overlapping uplink channels of the different priorities. The UE may receive additional control signaling including a collision resolution indication indicating the intra-UE prioritization or the intra-UE multiplexing for the overlapping uplink channels of the different priorities. FIG. 12B illustrates an example method of wireless communication 1250 in which the UE may further receive the additional control signaling, at 1203, including a collision resolution indication. At 1206, the UE may then transmit the uplink transmission including the one or more of the set of the overlapping uplink channels based on the semi-static configuration in the RRC message and the collision resolution indication in the additional control signaling. The additional control signaling may include DCI. FIG. 11 illustrates an example of the UE 1102 receiving DCI 1107 as an example of the additional control signaling. Each DCI format may include one or more bits of the collision resolution indication to indicate between the intra-UE prioritization and the intra-UE multiplexing. The semi-static configuration may further indicate one or more DCI formats that will include one or more bits of the collision resolution indication to indicate between the intra-UE prioritization and the intra-UE multiplexing.

In some aspects, the set of the overlapping channels may include a first channel scheduled by a first DCI, where the DCI includes the collision resolution indication between intra UE multiplexing or intra-UE prioritization, and at least one of: a second channel that is configured by RRC without a dynamic grant, or a third channel that is scheduled by a second DCI, wherein the DCI does not include a collision resolution indication field, and transmitting the uplink transmission, at 1206, includes the one or more of the overlapping uplink channels of the different priorities is based on the intra-UE prioritization or the intra-UE multiplexing indicated by the collision resolution indication in the first DCI.

In some aspects, the overlapping uplink channels may be RRC configured or configured by DCI not including a collision resolution indication. At 1204, the UE may apply a rule to perform at least one of: multiplexing the overlapping uplink channels, cancel at least one of the overlapping uplink channels, or apply a fourth RRC parameter. As an example, the set of overlapping uplink channels may include a first uplink channel that is RRC configured without a dynamic grant and a second uplink channel having a lower priority than the first uplink channel, the UE may receive an additional RRC parameter that indicates to: multiplex the overlapping uplink channels of the different priorities, or cancel at least one of the overlapping uplink channels of the different priorities, where the UE determines between the intra-UE prioritization or the intra-UE multiplexing for the set of overlapping uplink channels of the different priorities based on the additional RRC parameter. The additional RRC parameter may be associated with the first uplink channel that is RRC configured without a dynamic grant. The UE may apply the rule further based on a priority level associated with the overlapping uplink channels. The semi-static configuration or the additional RRC parameter may be a channel specific configuration. The channel specific configuration may be consistent across overlapping channels having a high priority level. The semi-static configuration may be a UE specific configuration, in some aspects. The UE may apply, e.g., at 1204, the collision resolution indication in the DCI that is different than the semi-static configuration in the RRC message based on the collision resolution indication indicating the intra-UE prioritization for the overlapping uplink channels.

In some aspects, the UE may receive scheduling information for a group of overlapping uplink channels, where at least one uplink channel being scheduled with a DCI includes a collision resolution indication. At 1204, the UE may apply a type of collision resolution based on the collision resolution indication in the scheduling information for a high priority uplink channel. The UE may receive scheduling information for a low priority (LP) channel in a second DCI that includes a second collision resolution indication, and the UE may ignore the second collision resolution in the second DCI based on the second DCI scheduling the LP channel when transmitting the uplink transmission at 1206.

In some aspects, the UE may receive scheduling information for a group of overlapping uplink channels including multiple uplink channels being scheduled with DCI including a collision resolution indication. At 1204, the UE may apply a type of collision resolution that is indicated in the DCI for the multiple uplink channels based on the collision resolution indication being the same in the DCI for the multiple uplink channels. The collision resolution indication may be consistent across overlapping channels having a high priority level.

In some aspects, the UE may receive first scheduling information for a first uplink channel and including a first collision resolution indication. The UE may receive, after the first scheduling information, second scheduling information for a second uplink channel that overlaps in time with the first uplink channel, the second scheduling information including a second collision resolution indication that is different than the first collision resolution indication. At 1204, the UE may apply the second collision resolution indication based on the second collision resolution indication indicating the intra-UE prioritization for the overlapping uplink channels of the different priorities.

In some aspects, the UE may receive a semi-static allocation for a set of overlapping uplink channels; receive DCI scheduling a high priority uplink channel; and drop or delay transmission of the set of overlapping uplink channels, where transmitting the uplink transmission, at 1206, includes transmitting the high priority uplink channel scheduled by the DCI. The dropping or the delaying of the transmission of the set of overlapping uplink channels, e.g., as determined at 1204, may be based on a multiplexed channel including the set of overlapping uplink channels being a low priority channel. The UE may delay the transmission of the set of overlapping uplink channels, and may transmit the set of overlapping uplink channels as a multiplexed transmission in a later transmission occasion.

In some aspects, the UE may receive a semi-static allocation for a set of overlapping uplink channels. The UE may receive DCI scheduling a high priority uplink channel. At 1204, the UE may drop any low priority channels of the set of overlapping uplink channels and multiplex one or more high priority channels of the set of overlapping uplink channels with the high priority uplink channel scheduled by the DCI, e.g., in order to transmit the uplink transmission at 1206. A timeline may be based on a threshold number of symbols prior to a final channel used to multiplex the set of overlapping channels.

The semi-static configuration may be the semi-static configuration for the dynamic indication between the intra-UE prioritization and the intra-UE multiplexing for the overlapping uplink channels of the different priorities, and the UE may receive DCI including a collision resolution indication based on a DCI size that is larger between a first DCI size associated with the intra-UE prioritization and a second DCI size associated with the intra-UE multiplexing.

In some aspects, the UE may receive a first grant for a high priority uplink channel. The UE may detect that an error has occurred based on reception, after the first grant, of a second grant for a low priority uplink channel that overlaps in time with the high priority uplink channel and a collision resolution indication in at least one of the first grant or the second grant indicates the intra-UE prioritization for the overlapping uplink channels of the different priorities.

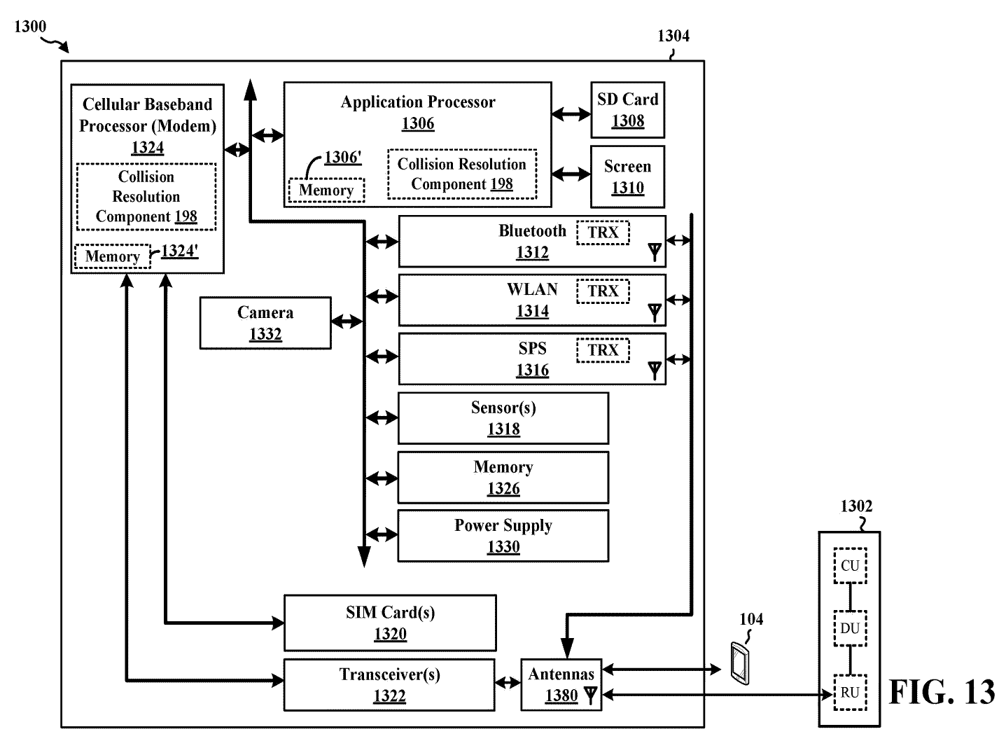

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a wireless local-area network (WLAN) module 1314, a satellite positioning system module 1316 (e.g., global navigation satellite system (GNSS) module), one or more sensor modules 1318 (e.g., barometric pressure sensor / altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium / memory 1324′, 1306′, respectively. The additional memory modules 1326 may also be considered a computer-readable medium / memory. Each computer-readable medium / memory 1324′, 1306′, 1326 may be non-transitory. The cellular baseband processor 1324 and the application processor 1306 are each responsible for general processing, including the execution of software stored on the computer-readable medium / memory. The software, when executed by the cellular baseband processor 1324 / application processor 1306, causes the cellular baseband processor 1324 / application processor 1306 to perform the various functions described supra. The computer-readable medium / memory may also be used for storing data that is manipulated by the cellular baseband processor 1324 / application processor 1306 when executing software. The cellular baseband processor 1324 / application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the collision resolution component 198 may be configured to receive an RRC message indicating a semi-static configuration for the UE for one of: intra-UE prioritization for overlapping uplink channels of different priorities, or intra-UE multiplexing for the overlapping uplink channels of the different priorities; determine between the intra-UE prioritization or the intra-UE multiplexing for a set of the overlapping uplink channels of the different priorities based, at least in part, on the RRC message; and transmit an uplink transmission including one or more of the set of the overlapping uplink channels based, at least in part, on the semi-static configuration in the RRC message. In some aspects, the collision resolution component 198 may be further configured to receive additional control signaling including a collision resolution indication indicating the intra-UE prioritization or the intra-UE multiplexing for the overlapping uplink channels, where the uplink transmission including the one or more of the overlapping uplink channels is transmitted based on the semi-static configuration in the RRC message and the collision resolution indication. The collision resolution component 198 may be configured to perform any of the aspects of the algorithm in the flowcharts of FIGS. 12A or 12B and/or the aspects performed by the UE in FIG. 11. The collision resolution component 198 may be within the cellular baseband processor 1324, the application processor 1306, or both the cellular baseband processor 1324 and the application processor 1306. The collision resolution component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1304 may include a variety of components configured for various functions. In one configuration, the apparatus 1304, and in particular the cellular baseband processor 1324 and/or the application processor 1306, includes means receiving an RRC message indicating a semi-static configuration for the UE for one of: intra-UE prioritization for overlapping uplink channels of different priorities, or intra-UE multiplexing for the overlapping uplink channels of the different priorities; means for determining between the intra-UE prioritization or the intra-UE multiplexing for a set of the overlapping uplink channels of the different priorities based, at least in part, on the RRC message; and means for transmitting an uplink transmission including one or more of the set of the overlapping uplink channels based, at least in part, on the semi-static configuration in the RRC message. The apparatus 1304 may further include means for receiving additional control signaling including a collision resolution indication indicating the intra-UE prioritization or the intra-UE multiplexing for the overlapping uplink channels, wherein transmitting the uplink transmission including the one or more of the overlapping uplink channels is based on the semi-static configuration in the RRC message and the collision resolution indication. The apparatus 1304 may further include means for receiving additional control signaling including a collision resolution indication indicating the intra-UE prioritization or the intra-UE multiplexing for the overlapping uplink channels, where the means for transmission of the uplink transmission including the one or more of the overlapping uplink channels is based on the semi-static configuration in the RRC message and the collision resolution indication. The apparatus 1304 may further include means for applying a rule to perform at least one of: multiplexing the overlapping uplink channels with the different priorities, canceling at least one of the overlapping uplink channels with the different priorities, or applying an additional RRC parameter. The apparatus 1304 may further include means for applying the collision resolution indication in the DCI that is different than the semi-static configuration in the RRC message based on the collision resolution indication indicating the intra-UE prioritization for the overlapping uplink channels of different priorities. The apparatus 1304 may further include means for receiving scheduling information for a group of overlapping uplink channels, wherein at least one uplink channel being scheduled with a DCI including a collision resolution indication; and means for applying a type of collision resolution based on the collision resolution indication in the scheduling information for a high priority uplink channel. The apparatus 1304 may further include means for receiving scheduling information for an LP channel in a second DCI, wherein the second DCI includes a second collision resolution indication; and means for ignoring the second collision resolution in the second DCI based on the second DCI scheduling the LP channel. The apparatus 1304 may further include means for receiving scheduling information for a group of overlapping uplink channels including multiple uplink channels being scheduled with DCI including a collision resolution indication, wherein the collision resolution indication is consistent across overlapping channels having a high priority level; and means for applying a type of collision resolution that is indicated in the DCI for the multiple uplink channels based on the collision resolution indication being the same in the DCI for the multiple uplink channels. The apparatus 1304 may further include means for receiving first scheduling information for a first uplink channel and including a first collision resolution indication; means for receiving, after the first scheduling information, second scheduling information for a second uplink channel that overlaps in time with the first uplink channel, the second scheduling information including a second collision resolution indication that is different than the first collision resolution indication; and means for applying the second collision resolution indication based on the second collision resolution indication indicating the intra-UE prioritization for the overlapping uplink channels. The apparatus 1304 may further include means for receiving a semi-static allocation for a set of overlapping uplink channels; means for receiving DCI scheduling a high priority uplink channel; and means for dropping or delaying transmission of the set of overlapping uplink channels, wherein transmitting the uplink transmission includes transmitting the high priority uplink channel scheduled by the DCI. The apparatus 1304 may further include means for transmitting the set of overlapping uplink channels as a multiplexed transmission in a later transmission occasion. The apparatus 1304 may further include means for receiving a semi-static allocation for a set of overlapping uplink channels; means for receiving DCI scheduling a high priority uplink channel; means for dropping any low priority channels of the set of overlapping uplink channels; and means for multiplexing one or more high priority channels of the set of overlapping uplink channels with the high priority uplink channel scheduled by the DCI. The apparatus 1304 may further include means for receiving a DCI including a collision resolution indication based on a DCI size that is larger between a first DCI size associated with the intra-UE prioritization and a second DCI size associated with the intra-UE multiplexing. The apparatus 1304 may further include means for receiving a first grant for a high priority uplink channel; and means for detecting that an error has occurred based on reception, after the first grant, of a second grant for a low priority uplink channel that overlaps in time with the high priority uplink channel and a collision resolution indication in at least one of the first grant or the second grant indicates the intra-UE prioritization for the overlapping uplink channels. The apparatus may further include means for performing any of the aspects of the algorithm in the flowcharts of FIGS. 12A or 12B and/or the aspects performed by the UE in FIG. 11. The means may be the collision resolution component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14A is a flowchart 1400 of a method of wireless communication. The method may be performed by a network entity or network node, such as a base station or a component of a base station (e.g., the base station 102/180; 310, 1104; the CU 1610; the DU 1630; the RU 1640; the network entity 1502). The method may enable a UE to determine between intra-UE prioritization and intra-UE multiplexing of overlapping uplink channels having different priorities. The method may improve communication between the network and the UE by reducing latency and improving collision resolution for overlapping uplink channels of different priorities.

At 1402, the network node transmits, to a UE, an RRC message indicating a semi-static configuration for the UE for one of: intra-UE prioritization for overlapping uplink channels of different priorities or intra-UE multiplexing for the overlapping uplink channels of different priorities. In some aspects, the semi-static configuration may configure the UE for a dynamic indication between the intra-UE prioritization and the intra-UE multiplexing for the overlapping uplink channels of the different priorities. FIG. 11 illustrates an example of a base station 1104 transmitting an RRC message, e.g., at 1106, to a UE 1102 indicating the semi-static configuration. In some aspects, the RRC message indicates the semi-static configuration for the UE for the intra-UE prioritization for the overlapping uplink channels of the different priorities or the intra-UE multiplexing for the overlapping uplink channels of the different priorities based on an RRC parameter indicating the intra-UE multiplexing being enabled or not enabled.

At 1404, the network node receives, from the UE, an uplink transmission including one or more of a set of the overlapping uplink channels based, at least in part, on the semi-static configuration in the RRC message. FIG. 11 illustrates an example of a base station 1104 receiving an uplink transmission from a UE 1102 based, at least in part, on the semi-static configuration in the RRC message, e.g., at 1106.

In some aspects, the RRC message may indicate the semi-static configuration for the intra-UE prioritization for the overlapping uplink channels of the different priorities, and the UE may receive, based on the semi-static configuration, a higher priority channel and skipping reception of a lower priority from the overlapping uplink channels.

In some aspects, the RRC message may indicate the semi-static configuration for the intra-UE multiplexing for the overlapping uplink channels of the different priorities, and the UE may receive, based on the semi-static configuration, a multiplexed transmission including a higher priority channel and a lower priority from the overlapping uplink channels.

In some aspects, the RRC message may indicate the semi-static configuration for the dynamic indication between the intra-UE prioritization and the intra-UE multiplexing for the overlapping uplink channels of the different priorities, and the network node may transmit additional control signaling including a collision resolution indication indicating the intra-UE prioritization or the intra-UE multiplexing for the overlapping uplink channels. FIG. 14B illustrates an example method of wireless communication 1450 in which the network node may further transmit the additional control signaling, at 1403, including a collision resolution indication. The uplink transmission including the one or more of the overlapping uplink channels may be received, at 1404, based on the semi-static configuration in the RRC message and the collision resolution indication. The additional control signaling may include DCI, e.g., such as the DCI 1107 in the example illustrated in FIG. 11. Each DCI format may include one or more bits of the collision resolution indication to indicate between the intra-UE prioritization and the intra-UE multiplexing. The semi-static configuration may further indicate one or more DCI formats that will include one or more bits of the collision resolution indication to indicate between the intra-UE prioritization and the intra-UE multiplexing.

The set of overlapping channels may include a first channel scheduled by a first DCI, where the DCI includes the indication between intra-UE multiplexing and intra-UE prioritization, and at least one of: a second channel that is configured by RRC without dynamic grant, or a third channel that is scheduled by a second DCI, where the DCI does not include the collision resolution indication, where the uplink transmission including the one or more of the overlapping uplink channels is received, at 1404, based on the intra-UE prioritization or the intra-UE multiplexing indicated by the collision resolution indication in the DCI.

The overlapping uplink channels may be RRC configured or configured by DCI including a collision resolution indication, and the network node may apply a rule to perform at least one of: receive a multiplexed transmission of the overlapping uplink channels, skip reception of at least one of the overlapping uplink channels, or receive the uplink transmission based on an additional RRC parameter. The rule may be further based on a priority level associated with the overlapping uplink channels. The semi-static configuration or the additional RRC parameter may be a channel specific configuration. The channel specific configuration may be consistent across overlapping channels having a high priority level. The semi-static configuration or the additional RRC parameter may be a UE specific configuration.

In some aspects, the network node may receive the uplink transmission, at 1404, based on the collision resolution indication in the DCI that is different than the semi-static configuration in the RRC message based on the collision resolution indication indicating the intra-UE prioritization for the overlapping uplink channels.

In some aspects, the network node may schedule information for a group of overlapping uplink channels, wherein at least one uplink channel being scheduled with a DCI including a collision resolution indication. The network node may receive the uplink transmission, at 1404, based on a type of collision resolution that is based on the collision resolution indication in the scheduling information for a high priority uplink channel.

In some aspects, the network node may schedule information for a low priority (LP) channel in a second DCI, wherein the second DCI includes a second collision resolution, the second collision resolution in the second DCI to be ignored based on the second DCI scheduling the LP channel.

In some aspects, the network node may schedule information for a group of overlapping uplink channels including multiple uplink channels being scheduled with DCI including a collision resolution indication. The network node may receive the uplink transmission, at 1404, based on a type of collision resolution that is indicated in the DCI for the multiple uplink channels based on the collision resolution indication being the same in the DCI for the multiple uplink channels.

In some aspects, the collision resolution indication may be consistent across overlapping channels having a high priority level.

In some aspects, the base station may transmit first scheduling information for a first uplink channel and including a first collision resolution indication and transmit, after the first scheduling information, second scheduling information for a second uplink channel that overlaps in time with the first uplink channel, the second scheduling information including a second collision resolution indication that is different than the first collision resolution indication. In order to receive the uplink transmission, at 1404, the network node may apply the second collision resolution indication based on the second collision resolution indication indicating the intra-UE prioritization for the overlapping uplink channels.

In some aspects, the network node may transmit a semi-static allocation for a set of overlapping uplink channels and transmit DCI scheduling a high priority uplink channel. At 1404, the network node may drop or delay reception of one of the set of overlapping uplink channels, where reception of the uplink transmission, at 1404, includes receiving the high priority uplink channel scheduled by the DCI.

In some aspects dropping or the delaying of the reception of the set of overlapping uplink channels may be based on a multiplexed channel including the set of overlapping uplink channels being a low priority channel.

In some aspects, the network node may delay the reception of the set of overlapping uplink channels, and may receive the set of overlapping uplink channels as a multiplexed transmission during a later transmission occasion.

In some aspects, the network node may transmit a semi-static allocation for a set of overlapping uplink channels; and transmit DCI scheduling a high priority uplink channel, wherein receiving the uplink transmission is based on any low priority channels of the set of overlapping uplink channels being dropped and one or more high priority channels of the set of overlapping uplink channels being multiplexed with the high priority uplink channel scheduled by the DCI. A timeline may be based on a threshold number of symbols prior to a final channel used to multiplex the set of overlapping channels.

In some aspects, the semi-static configuration may be the third semi-static configuration for the dynamic indication between the intra-UE prioritization and the intra-UE multiplexing for the overlapping uplink channels, the network node may transmit a DCI including a collision resolution indication based on a DCI size that is larger between a first DCI size associated with the intra-UE prioritization and a second DCI size associated with the intra-UE multiplexing.

The network node may transmit a first grant for a high priority uplink channel and avoid transmitting, after the first grant, a second grant for a low priority uplink channel that overlaps in time with the high priority uplink channel and a collision resolution indication in at least one of the first grant or the second grant indicates the intra-UE prioritization for the overlapping uplink channels.

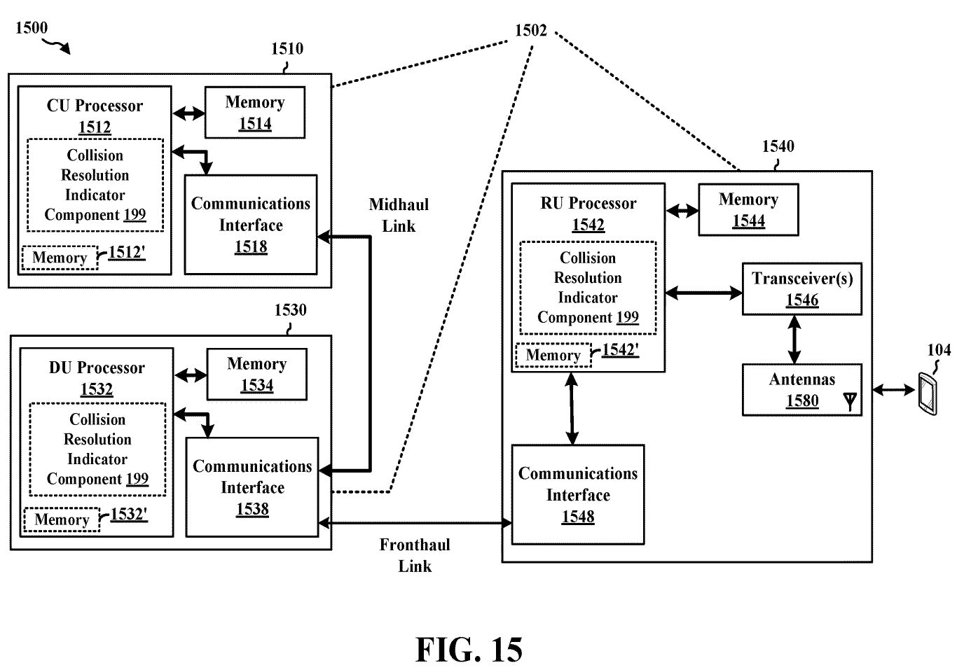

FIG. 15 is a diagram 1500 illustrating an example of a hardware implementation for a network entity 1502, which may also be referred to as a network node. The network entity 1502 may be a base station, a component of a base station, or may implement base station functionality. The network entity 1502 may include at least one of a CU 1510, a DU 1530, or an RU 1540. For example, depending on the layer functionality handled by the collision resolution indicator component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium / memory. Each computer-readable medium / memory may be non-transitory. Each of the processors 1512, 1532, 1542 is responsible for general processing, including the execution of software stored on the computer-readable medium / memory. The software, when executed by the corresponding processor(s) causes the processor(s) to perform the various functions described supra. The computer-readable medium / memory may also be used for storing data that is manipulated by the processor(s) when executing software.

As discussed supra, the collision resolution indicator component 199 may be configured to transmit, to a UE, an RRC message indicating a semi-static configuration for the UE for one of: intra-UE prioritization for overlapping uplink channels of different priorities, or intra-UE multiplexing for the overlapping uplink channels of different priorities; and receive, from the UE, an uplink transmission including one or more of a set of the overlapping uplink channels based, at least in part, on the semi-static configuration in the RRC message. In some aspects, the RRC message may indicate a semi-static configuration for a dynamic indication between the intra-UE prioritization and the intra-UE multiplexing for the overlapping uplink channels, and the collision resolution indicator component 199 may be further configured to transmit additional control signaling including a collision resolution indication indicating the intra-UE prioritization or the intra-UE multiplexing for the overlapping uplink channels, where the uplink transmission including the one or more of the overlapping uplink channels is based on the semi-static configuration in the RRC message and the collision resolution indication. The collision resolution indicator component 199 may be within one or more processors of one or more of the CU 1510, DU 1530, and the RU 1540. The collision resolution indicator component 199 may be further configured to perform any of the aspects of the flowcharts of FIGS. 14A, 14B, and/or the aspects performed by the base station in FIG. 11. The collision resolution indicator component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for transmitting, to a UE, an RRC message indicating a semi-static configuration for the UE for one of: intra-UE prioritization for overlapping uplink channels of different priorities, or intra-UE multiplexing for the overlapping uplink channels of different priorities; and means for receiving, from the UE, an uplink transmission including one or more of a set of the overlapping uplink channels based, at least in part, on the semi-static configuration in the RRC message. In some aspects, the RRC message may indicate a semi-static configuration for a dynamic indication between the intra-UE prioritization and the intra-UE multiplexing for the overlapping uplink channels, and the network entity may further include means for transmitting additional control signaling including a collision resolution indication indicating the intra-UE prioritization or the intra-UE multiplexing for the overlapping uplink channels, where the uplink transmission including the one or more of the overlapping uplink channels is based on the semi-static configuration in the RRC message and the collision resolution indication. The network entity may further include means for performing any of the aspects of the flowcharts of FIGS. 14A, 14B, and/or the aspects performed by the base station in FIG. 11. The means may be the collision resolution indicator component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

Deployment of communication systems, such as 5G new radio (NR) systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

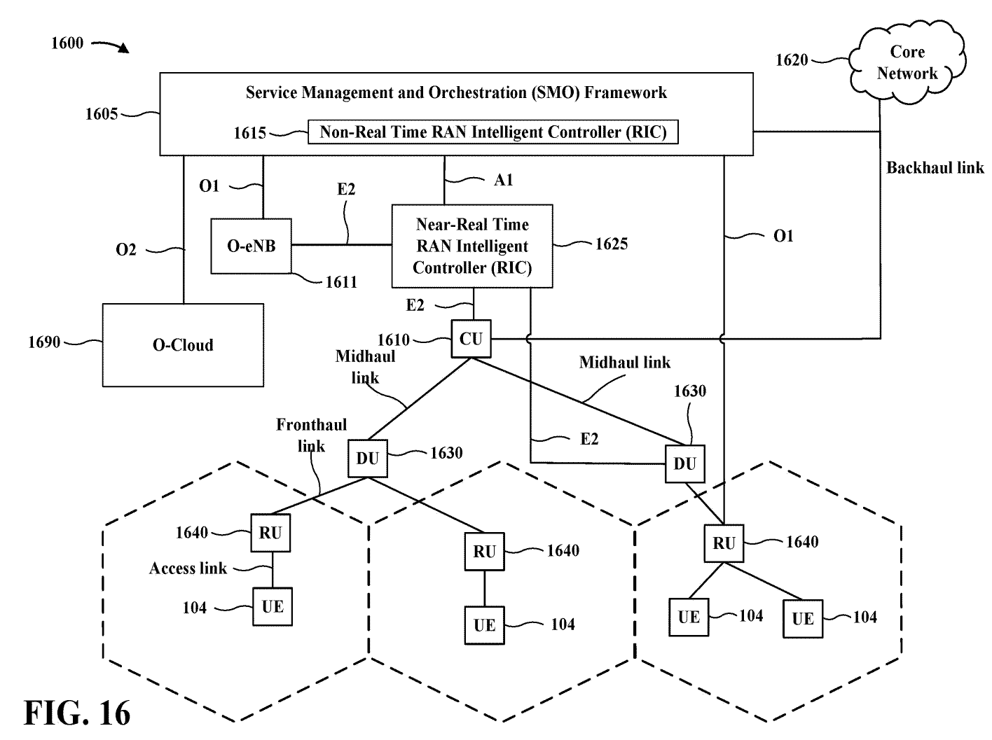

FIG. 16 shows a diagram illustrating an example disaggregated base station 1600 architecture. The disaggregated base station 1600 architecture may include one or more central units (CUs) 1610 that can communicate directly with a core network 1620 via a backhaul link, or indirectly with the core network 1620 through one or more disaggregated base station units (such as a Near-Real Time (Near-RT) RAN Intelligent Controller (RIC) 1625 via an E2 link, or a Non-Real Time (Non-RT) RIC 1615 associated with a Service Management and Orchestration (SMO) Framework 1605, or both). A CU 1610 may communicate with one or more distributed units (DUs) 1630 via respective midhaul links, such as an F1 interface. The DUs 1630 may communicate with one or more radio units (RUs) 1640 via respective fronthaul links. The RUs 1640 may communicate with respective UEs 104 via one or more radio frequency (RF) access links. In some implementations, the UE 104 may be simultaneously served by multiple RUs 1640.

Each of the units, i.e., the CUs 1610, the DUs 1630, the RUs 1640, as well as the Near-RT RICs 1625, the Non-RT RICs 1615 and the SMO Framework 1605, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1610 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1610. The CU 1610 may be configured to handle user plane functionality (i.e., Central Unit - User Plane (CU-UP)), control plane functionality (i.e., Central Unit - Control Plane (CU-CP)), or a combination thereof. In some implementations, the CU 1610 can be logically split into one or more CU-UP units and one or more CU-CP units. The CU-UP unit can communicate bidirectionally with the CU-CP unit via an interface, such as the E1 interface when implemented in an O-RAN configuration. The CU 1610 can be implemented to communicate with the DU 1630, as necessary, for network control and signaling.

The DU 1630 may correspond to a logical unit that includes one or more base station functions to control the operation of one or more RUs 1640. In some aspects, the DU 1630 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 1630 may further host one or more low PHY layers. Each layer (or module) can be implemented with an interface configured to communicate signals with other layers (and modules) hosted by the DU 1630, or with the control functions hosted by the CU 1610.

Lower-layer functionality can be implemented by one or more RUs 1640. In some deployments, an RU 1640, controlled by a DU 1630, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1640 can be implemented to handle over the air (OTA) communication with one or more UEs 104. In some implementations, real-time and non-real-time aspects of control and user plane communication with the RU(s) 1640 can be controlled by the corresponding DU 1630. In some scenarios, this configuration can enable the DU(s) 1630 and the CU 1610 to be implemented in a cloud-based RAN architecture, such as a vRAN architecture.

The SMO Framework 1605 may be configured to support RAN deployment and provisioning of non-virtualized and virtualized network elements. For non-virtualized network elements, the SMO Framework 1605 may be configured to support the deployment of dedicated physical resources for RAN coverage requirements which may be managed via an operations and maintenance interface (such as an O1 interface). For virtualized network elements, the SMO Framework 1605 may be configured to interact with a cloud computing platform (such as an open cloud (O-Cloud) 1690) to perform network element life cycle management (such as to instantiate virtualized network elements) via a cloud computing platform interface (such as an O2 interface). Such virtualized network elements can include, but are not limited to, CUs 1610, DUs 1630, RUs 1640 and Near-RT RICs 1625. In some implementations, the SMO Framework 1605 can communicate with a hardware aspect of a 4G RAN, such as an open eNB (O-eNB) 1611, via an O1 interface. Additionally, in some implementations, the SMO Framework 1605 can communicate directly with one or more RUs 1640 via an O1 interface. The SMO Framework 1605 also may include a Non-RT RIC 1615 configured to support functionality of the SMO Framework 1605.

The Non-RT RIC 1615 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1625. The Non-RT RIC 1615 may be coupled to or communicate with (such as via an A1 interface) the Near-RT RIC 1625. The Near-RT RIC 1625 may be configured to include a logical function that enables near-real-time control and optimization of RAN elements and resources via data collection and actions over an interface (such as via an E2 interface) connecting one or more CUs 1610, one or more DUs 1630, or both, as well as an O-eNB, with the Near-RT RIC 1625.

In some implementations, to generate AI/ML models to be deployed in the Near-RT RIC 1625, the Non-RT RIC 1615 may receive parameters or external enrichment information from external servers. Such information may be utilized by the Near-RT RIC 1625 and may be received at the SMO Framework 1605 or the Non-RT RIC 1615 from non-network data sources or from network functions. In some examples, the Non-RT RIC 1615 or the Near-RT RIC 1625 may be configured to tune RAN behavior or performance. For example, the Non-RT RIC 1615 may monitor long-term trends and patterns for performance and employ AI/ML models to perform corrective actions through the SMO Framework 1605 (such as reconfiguration via O1) or via creation of RAN management policies (such as A1 policies).

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not limited to the specific order or hierarchy presented.

previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving an RRC message indicating a semi-static configuration for the UE for one of: intra-UE prioritization for overlapping uplink channels of different priorities, or intra-UE multiplexing for the overlapping uplink channels of the different priorities; determining between the intra-UE prioritization or the intra-UE multiplexing for a set of overlapping uplink channels of the different priorities based, at least in part, on the RRC message; and transmitting an uplink transmission including one or more of the set of overlapping uplink channels based, at least in part, on the semi-static configuration in the RRC message.

In aspect 2, the method of aspect 1 further includes that the RRC message indicates the semi-static configuration for the intra-UE prioritization for the overlapping uplink channels, and the transmitting the uplink transmission includes transmitting a higher priority channel and dropping transmission of a lower priority from the set of the overlapping uplink channels based on the semi-static configuration.

In aspect 3, the method of aspect 1 further includes that the RRC message indicates the semi-static configuration for the intra-UE multiplexing for the overlapping uplink channels, and the transmitting the uplink transmission includes multiplexing a higher priority channel and a lower priority channel from the set of the overlapping uplink channels based on the semi-static configuration.

In aspect 4, the method of aspect 1 further includes that the RRC message indicates the semi-static configuration for a dynamic indication between the intra-UE prioritization and the intra-UE multiplexing for the overlapping uplink channels, the method further comprising: receiving additional control signaling including a collision resolution indication indicating the intra-UE prioritization or the intra-UE multiplexing for the overlapping uplink channels, wherein transmitting the uplink transmission including the one or more of the set of the overlapping uplink channels is based on the semi-static configuration in the RRC message and the collision resolution indication.

In aspect 5, the method of aspect 4 further includes that the additional control signaling comprises DCI.

In aspect 6, the method of aspect 5 further includes that each DCI format includes one or more bits of the collision resolution indication to indicate between the intra-UE prioritization and the intra-UE multiplexing.

In aspect 7, the method of aspect 5 or aspect 6 further includes that the semi-static configuration further indicates one or more DCI formats that will include the one or more bits of the collision resolution indication to indicate one of the intra-UE prioritization and the intra-UE multiplexing.

In aspect 8, the method of any of aspects 1-7 further includes that the set of the overlapping channels includes a first channel scheduled by a first DCI, where the DCI includes a collision resolution indication between intra-UE multiplexing and intra-UE prioritization, and at least one of: a second channel that is configured by RRC without a dynamic grant, or a third channel that is scheduled by a second DCI, wherein the DCI does not include a collision resolution indication field, wherein transmitting the uplink transmission including the one or more of the set of the overlapping uplink channels is based on the intra-UE prioritization or the intra-UE multiplexing indicated by the collision resolution indication in the first DCI.

In aspect 9, the method of any of aspects 1-7 further includes that the set of overlapping uplink channels includes a first uplink channel that is RRC configured without a dynamic grant and a second uplink channel having a lower priority than the first uplink channel, the method further comprising: receiving an additional RRC parameter that indicates to: multiplex the overlapping uplink channels of the different priorities, or cancel at least one of the overlapping uplink channels of the different priorities, where the UE determines between the intra-UE prioritization or the intra-UE multiplexing for the set of the overlapping uplink channels of the different priorities based on the additional RRC parameter.

In aspect 10, the method of aspect 9 further includes that the UE applies the rule further based on a priority level associated with the overlapping uplink channels.

In aspect 11, the method of aspect 9 or aspect 10 further includes that the additional RRC parameter is associated with the first uplink channel that is RRC configured without the dynamic grant.

In aspect 12, the method of any of aspect 1-11 further includes that the additional RRC parameter is a channel specific configuration.

In aspect 13, the method of any of aspect 1-11 further includes that the semi-static configuration is a UE specific configuration.

In aspect 14, the method of any of aspects 1-7 further includes applying the collision resolution indication in the DCI that is different than the semi-static configuration in the RRC message based on the collision resolution indication indicating the intra-UE prioritization for the overlapping uplink channels of different priorities.

In aspect 15, the method of any of aspects 1 or 4-7 further includes receiving scheduling information for a group of overlapping uplink channels, wherein at least one uplink channel being scheduled with a DCI including a collision resolution indication; and applying a type of collision resolution based on the collision resolution indication in the scheduling information for a high priority uplink channel.

In aspect 16, the method of aspect 15 further includes receiving scheduling information for an LP channel in a second DCI, wherein the second DCI includes a second collision resolution indication; and ignoring the second collision resolution in the second DCI based on the second DCI scheduling the LP channel.

In aspect 17, the method of any of aspects 1 or 4-7 further includes receiving scheduling information for a group of overlapping uplink channels including multiple uplink channels being scheduled with DCI including a collision resolution indication; and applying a type of collision resolution that is indicated in the DCI for the multiple uplink channels based on a same collision resolution indication being indicated in the DCI for the multiple uplink channels.

In aspect 18, the method of aspect 17 further includes that the collision resolution indication is consistent across overlapping channels having a high priority level.

In aspect 19, the method of any of aspects 1 or 4-7 further includes receiving first scheduling information for a first uplink channel and including a first collision resolution indication; receiving, after the first scheduling information, second scheduling information for a second uplink channel that overlaps in time with the first uplink channel, the second scheduling information including a second collision resolution indication that is different than the first collision resolution indication; and applying the second collision resolution indication based on the second collision resolution indication indicating the intra-UE prioritization for the overlapping uplink channels.

In aspect 20, the method of any of aspects 1-3 and 9-14 further includes that the RRC message indicates the semi-static configuration for the UE for the intra-UE prioritization for the overlapping uplink channels of the different priorities or the intra-UE multiplexing for the overlapping uplink channels of the different priorities based on an RRC parameter indicating the intra-UE multiplexing being enabled or not enabled.

In aspect 21, the method of any of aspects, 1 or 4-7 further includes that the semi-static configuration is the semi-static configuration for a dynamic indication between the intra-UE prioritization and the intra-UE multiplexing for the overlapping uplink channels, the method further comprising: receiving a DCI including a collision resolution indication based on a DCI size that is larger between a first DCI size associated with the intra-UE prioritization and a second DCI size associated with the intra-UE multiplexing.

Aspect 22 is an apparatus for wireless communication at a UE comprising means for performing the method of any of aspects 1-21.

Aspect 23 is an apparatus for wireless communication at a UE, comprising memory and at least one processor coupled to the memory and configured to perform the method of any of aspects 1-21.

Aspect 24 is the apparatus of claim 22 or claim 23 further comprising one or more of at least one transceiver or at least one antenna coupled to the at least one processor.

Aspect 25 is a non-transitory computer-readable medium storing computer executable code, where the code when executed by a processor causes the processor to perform the method of any of aspects 1-21.

Aspect 26 is a method of wireless communication at a network node, comprising: transmitting, to a UE, an RRC message indicating a semi-static configuration for the UE for one of: intra-UE prioritization for overlapping uplink channels of different priorities, or intra-UE multiplexing for the overlapping uplink channels of different priorities; and receiving, from the UE, an uplink transmission including one or more of a set of overlapping uplink channels based, at least in part, on the semi-static configuration in the RRC message.

In aspect 27, the method of aspect 26 further includes that the RRC message indicates the semi-static configuration for the intra-UE prioritization for the overlapping uplink channels, and the receiving the uplink transmission includes receiving, based on the semi-static configuration, a higher priority channel and skipping reception of a lower priority from the set of the overlapping uplink channels.

In aspect 28, the method of aspect 26 further includes that the RRC message indicates the semi-static configuration for the intra-UE multiplexing for the overlapping uplink channels, and the receiving the uplink transmission includes receiving, based on the semi-static configuration, a multiplexed transmission including a higher priority channel and a lower priority from the set of the overlapping uplink channels.

In aspect 29, the method of aspect 26 further includes that the RRC message indicates the semi-static configuration for a dynamic indication between the intra-UE prioritization and the intra-UE multiplexing for the overlapping uplink channels, the method further comprising: transmitting additional control signaling including a collision resolution indication indicating the intra-UE prioritization or the intra-UE multiplexing for the overlapping uplink channels, wherein the uplink transmission including the one or more of the set of the overlapping uplink channels is based on the semi-static configuration in the RRC message and the collision resolution indication.

In aspect 30, the method of aspect 29 further includes that the additional control signaling comprises DCI.

In aspect 31, the method of aspect 30 further includes that each DCI format includes one or more bits of the collision resolution indication to indicate between the intra-UE prioritization and the intra-UE multiplexing.

In aspect 32, the method of aspect 30 or 31 further includes that configuration further indicates one or more DCI formats that will include one or more bits of the collision resolution indication to indicate between the intra-UE prioritization and the intra-UE multiplexing.

In aspect 33, the method of any of aspects 30-32 further includes that the set of overlapping channels includes a first channel scheduled by a first DCI, where the DCI includes the indication between intra-UE multiplexing and intra-UE prioritization, and at least one of: a second channel that is configured by RRC without dynamic grant, or a third channel that is scheduled by a second DCI, wherein the DCI does not include the collision resolution indication, wherein the uplink transmission including the one or more of the set of the overlapping uplink channels is based on the intra-UE prioritization or the intra-UE multiplexing indicated by the collision resolution indication in the DCI.

In aspect 34, the method of any of aspects 29-33 further includes that the overlapping uplink channels are RRC configured or configured by DCI including a collision resolution indication, the method further comprising applying a rule to perform at least one of: receive a multiplexed transmission of the overlapping uplink channels, skip reception of at least one of the set of the overlapping uplink channels, or receive the uplink transmission based on an additional RRC parameter.

In aspect 35, the method of any of aspects 26-28 further includes that the set of overlapping uplink channels includes a first uplink channel that is RRC configured without a dynamic grant and a second uplink channel having a lower priority than the first uplink channel, the method further comprising: receive an additional RRC parameter that indicates to: multiplex the overlapping uplink channels of the different priorities, or cancel at least one of the set of the overlapping uplink channels of the different priorities, wherein the UE determines between the intra-UE prioritization or the intra-UE multiplexing for the set of the overlapping uplink channels of the different priorities based on the additional RRC parameter.

In aspect 36, the method of aspect 35 further includes that the additional RRC parameter is associated with the first uplink channel that is RRC configured without the dynamic grant.

In aspect 37, the method of aspect 35 or 36 further includes that the additional RRC parameter is a channel specific configuration.

In aspect 38, the method of any of aspects 35-37 further includes that the semi-static configuration is a UE specific configuration.

In aspect 39, the method of any of aspects 26 or 29-32 further includes receiving the uplink transmission based on the collision resolution indication in the DCI that is different than the semi-static configuration in the RRC message based on the collision resolution indication indicating the intra-UE prioritization for the overlapping uplink channels.

In aspect 40, the method of any of aspects 26 or 29-32 further includes transmitting scheduling information for a group of overlapping uplink channels, wherein at least one uplink channel being scheduled with a DCI including a collision resolution indication; and receiving the uplink transmission based on a type of collision resolution that is based on the collision resolution indication in the scheduling information for a high priority uplink channel.

In aspect 41, the method of any of aspects 26 or 29-32 further includes transmitting scheduling information for a group of overlapping uplink channels including multiple uplink channels being scheduled with DCI including a collision resolution indication; and receiving the uplink transmission based on a type of collision resolution that is indicated in the DCI for the multiple uplink channels based on the collision resolution indication being the same in the DCI for the multiple uplink channels.

In aspect 42, the method of any of aspects 26 or 29-32 further includes transmitting first scheduling information for a first uplink channel and including a first collision resolution indication; transmitting, after the first scheduling information, second scheduling information for a second uplink channel that overlaps in time with the first uplink channel, the second scheduling information including a second collision resolution indication that is different than the first collision resolution indication; and receiving one or more of the set of uplink transmissions based on the second collision resolution indication based on the second collision resolution indication indicating the intra-UE prioritization for the overlapping uplink channels.

In aspect 43, the method of any of aspects 26-28 further includes that the RRC message indicates the semi-static configuration for the UE for the intra-UE prioritization for the overlapping uplink channels of the different priorities or the intra-UE multiplexing for the overlapping uplink channels of the different priorities based on an RRC parameter indicating the intra-UE multiplexing being enabled or not enabled.

In aspect 44, the method of any of aspects 26 or 29-32 further includes that the configuration is the third semi-static configuration for the dynamic indication between the intra-UE prioritization and the intra-UE multiplexing for the overlapping uplink channels, the method further comprising: transmitting a DCI including a collision resolution indication based on a DCI size that is larger between a first DCI size associated with the intra-UE prioritization and a second DCI size associated with the intra-UE multiplexing.

Aspect 45 is an apparatus for wireless communication at a network node comprising means for performing the method of any of aspects 26-44.

Aspect 46 is an apparatus for wireless communication at a network node, comprising memory and at least one processor coupled to the memory and configured to perform the method of any of aspects 26-44.

Aspect 47 is the apparatus of claim 45 or claim 46 further comprising one or more of at least one transceiver or at least one antenna coupled to the at least one processor.

Aspect 48 is a non-transitory computer-readable medium storing computer executable code, where the code when executed by a processor causes the processor to perform the method of any of aspects 26-44.

What is claimed is:

1. A method of wireless communication at a user equipment (UE), comprising:
receiving a radio resource control (RRC) message indicating a semi-static configuration for the UE for one of:
intra-UE prioritization for overlapping uplink channels of different priorities, or
intra-UE multiplexing for the overlapping uplink channels of the different priorities;
determining between the intra-UE prioritization or the intra-UE multiplexing for a set of overlapping uplink channels of the different priorities based, at least in part, on the RRC message; and
transmitting an uplink transmission including one or more of the set of overlapping uplink channels based, at least in part, on the semi-static configuration in the RRC message.

2. The method of claim 1, wherein the RRC message indicates the semi-static configuration for the intra-UE prioritization for the overlapping uplink channels, and the transmitting the uplink transmission includes transmitting a higher priority channel and dropping transmission of a lower priority from the overlapping uplink channels based on the semi-static configuration.

3. The method of claim 1, wherein the RRC message indicates the semi-static configuration for the intra-UE multiplexing for the overlapping uplink channels, and the transmitting the uplink transmission includes multiplexing a higher priority channel and a lower priority channel from the overlapping uplink channels based on the semi-static configuration.

4. The method of claim 1, wherein the RRC message indicates the semi-static configuration for a dynamic indication between the intra-UE prioritization and the intra-UE multiplexing for the overlapping uplink channels, the method further comprising:
receiving additional control signaling including a collision resolution indication indicating the intra-UE prioritization or the intra-UE multiplexing for the overlapping uplink channels,
wherein transmitting the uplink transmission including the one or more of the set of overlapping uplink channels is based on the semi-static configuration in the RRC message and the collision resolution indication.

5. The method of claim 4, wherein the additional control signaling comprises downlink control information (DCI), wherein each DCI format includes one or more bits of the collision resolution indication to indicate between the intra-UE prioritization and the intra-UE multiplexing, and wherein the semi-static configuration further indicates one or more DCI formats that will include the one or more bits of the collision resolution indication to indicate one of the intra-UE prioritization and the intra-UE multiplexing.

6. The method of claim 1, wherein the set of overlapping channels includes a first channel scheduled by a first DCI, where the DCI includes a collision resolution indication between intra-UE multiplexing and intra-UE prioritization, and at least one of:
a second channel that is configured by RRC without a dynamic grant, or
a third channel that is scheduled by a second DCI, wherein the DCI does not include a collision resolution indication field,
wherein transmitting the uplink transmission including the one or more of the set of overlapping uplink channels is based on the intra-UE prioritization or the intra-UE multiplexing indicated by the collision resolution indication in the first DCI.

7. The method of claim 1, wherein the set of overlapping uplink channels includes a first uplink channel that is RRC configured without a dynamic grant and a second uplink channel having a lower priority than the first uplink channel, the method further comprising:
receiving an additional RRC parameter that indicates to:
multiplex the overlapping uplink channels of the different priorities, or
cancel at least one of the set of overlapping uplink channels of the different priorities, wherein the UE determines between the intra-UE prioritization or the intra-UE multiplexing for the set of overlapping uplink channels of the different priorities based on the additional RRC parameter.

8. The method of claim 7, wherein the additional RRC parameter is associated with the first uplink channel that is RRC configured without the dynamic grant.

9. The method of claim 8, wherein the additional RRC parameter is a channel specific configuration.

10. The method of claim 8, wherein the semi-static configuration is a UE specific configuration.

11. The method of claim 7, further comprising:
applying a collision resolution indication in downlink control information (DCI) that is different than the semi-static configuration in the RRC message based on the collision resolution indication indicating the intra-UE prioritization for the set of overlapping uplink channels of different priorities.

12. The method of claim 1, further comprising:
receiving scheduling information for a group of overlapping uplink channels, wherein at least one uplink channel is scheduled with a downlink control information (DCI) including a collision resolution indication; and
applying a type of collision resolution based on the collision resolution indication in the scheduling information for a high priority uplink channel.

13. The method of claim 1, further comprising:
receiving scheduling information for a group of overlapping uplink channels including multiple uplink channels being scheduled with downlink control information (DCI) including a collision resolution indication, wherein the collision resolution indication is consistent across overlapping channels having a high priority level; and
applying a type of collision resolution that is indicated in the DCI for the multiple uplink channels based on a same collision resolution indication being indicated in the DCI for the multiple uplink channels.

14. The method of claim 1, further comprising:
receiving first scheduling information for a first uplink channel and including a first collision resolution indication;
receiving, after the first scheduling information, second scheduling information for a second uplink channel that overlaps in time with the first uplink channel, the second scheduling information including a second collision resolution indication that is different than the first collision resolution indication; and
applying the second collision resolution indication based on the second collision resolution indication indicating the intra-UE prioritization for the overlapping uplink channels.

15. The method of claim 1, wherein the RRC message indicates the semi-static configuration for the UE for the intra-UE prioritization for the overlapping uplink channels of the different priorities or the intra-UE multiplexing for the overlapping uplink channels of the different priorities based on an RRC parameter indicating the intra-UE multiplexing being enabled or not enabled.

16. The method of claim 1, wherein the semi-static configuration is the semi-static configuration for a dynamic indication between the intra-UE prioritization and the intra-UE multiplexing for the overlapping uplink channels, the method further comprising:
receiving a downlink control information (DCI) including a collision resolution indication based on a DCI size that is larger between a first DCI size associated with the intra-UE prioritization and a second DCI size associated with the intra-UE multiplexing.

17. An apparatus for wireless communication at a user equipment (UE), comprising:
a memory; and
at least one processor coupled to the memory and, based at least in part on information stored in the memory, the at least one processor is configured to:
receive a radio resource control (RRC) message indicating a semi-static configuration for the UE for one of:
intra-UE prioritization for overlapping uplink channels of different priorities, or
intra-UE multiplexing for the overlapping uplink channels of the different priorities;
determine between the intra-UE prioritization or the intra-UE multiplexing for a set of the overlapping uplink channels of the different priorities based, at least in part, on the RRC message; and
transmit an uplink transmission including one or more of the set of the overlapping uplink channels based, at least in part, on the semi-static configuration in the RRC message.

18. The apparatus of claim 17, wherein the RRC message indicates the semi-static configuration for the intra-UE prioritization for the overlapping uplink channels, and to transmit the uplink transmission, the at least one processor is configured to transmit a higher priority channel and drop transmission of a lower priority from the set of the overlapping uplink channels based on the semi-static configuration.

19. The apparatus of claim 17, wherein the RRC message indicates the semi-static configuration for the intra-UE multiplexing for the overlapping uplink channels, and to transmit the uplink transmission, the at least one processor is configured to multiplex a higher priority channel and a lower priority channel from the set of the overlapping uplink channels based on the semi-static configuration.

20. The apparatus of claim 17, wherein the RRC message indicates the semi-static configuration for a dynamic indication between the intra-UE prioritization and the intra-UE multiplexing for the overlapping uplink channels, wherein the at least one processor is further configured to:
receive additional control signaling including a collision resolution indication indicating the intra-UE prioritization or the intra-UE multiplexing for the overlapping uplink channels,
wherein to transmit the uplink transmission, the at least one processor is configured to transmit the uplink transmission including the one or more of the set of the overlapping uplink channels based on the semi-static configuration in the RRC message and the collision resolution indication.

21. The apparatus of claim 17, wherein the set of the one or more overlapping channels includes a first channel scheduled by a first DCI, where the DCI includes a collision resolution indication between intra-UE multiplexing and intra-UE prioritization, and at least one of:
a second channel that is configured by RRC without a dynamic grant, or
a third channel that is scheduled by a second DCI, wherein the DCI does not include a collision resolution indication field,
wherein to transmit the uplink transmission, the at least one processor is configured to transmit the uplink transmission including the one or more of the set of the overlapping uplink channels based on the intra-UE prioritization or the intra-UE multiplexing indicated by the collision resolution indication in the first DCI.

22. The apparatus of claim 17, wherein the set of the overlapping uplink channels are RRC configured or configured by downlink control information (DCI) not including a collision resolution indication, wherein the at least one processor is further configured to apply a rule to perform at least one of:
multiplex the overlapping uplink channels of the different priorities,
cancel at least one of the overlapping uplink channels of the different priorities, or
apply an additional RRC parameter.

23. The apparatus of claim 22, wherein the semi-static configuration or the additional RRC parameter is a channel specific configuration or a UE specific configuration.

24. The apparatus of claim 17, further including:
at least one transceiver coupled to the at least one processor and configured to receive the RRC message and transmit the uplink transmission.

25. An apparatus for wireless communication at a user equipment (UE), comprising:
means for receiving a radio resource control (RRC) message indicating a semi-static configuration for the UE for one of:
intra-UE prioritization for overlapping uplink channels of different priorities, or
intra-UE multiplexing for the overlapping uplink channels of the different priorities;
means for determining between the intra-UE prioritization or the intra-UE multiplexing for a set of the overlapping uplink channels of the different priorities based, at least in part, on the RRC message; and
means for transmitting an uplink transmission including one or more of the set of the overlapping uplink channels based, at least in part, on the semi-static configuration in the RRC message.

26. A method of wireless communication at a network node, comprising:
transmitting, to a user equipment (UE), a radio resource control (RRC) message indicating a semi-static configuration for the UE for one of:
intra-UE prioritization for overlapping uplink channels of different priorities, or
intra-UE multiplexing for the overlapping uplink channels of different priorities; and
receiving, from the UE, an uplink transmission including one or more of a set of overlapping uplink channels based, at least in part, on the semi-static configuration in the RRC message.

27. The method of claim 26, wherein the RRC message indicates the semi-static configuration for the intra-UE prioritization for the overlapping uplink channels, and the receiving the uplink transmission includes receiving, based on the semi-static configuration, a higher priority channel and skipping reception of a lower priority from the set of the overlapping uplink channels.

28. The method of claim 26, wherein the RRC message indicates the semi-static configuration for the intra-UE multiplexing for the overlapping uplink channels, and the receiving the uplink transmission includes receiving, based on the semi-static configuration, a multiplexed transmission including a higher priority channel and a lower priority from the set of the overlapping uplink channels.

29. The method of claim 26, wherein the RRC message indicates the semi-static configuration for a dynamic indication between the intra-UE prioritization and the intra-UE multiplexing for the overlapping uplink channels, the method further comprising:
transmitting additional control signaling including a collision resolution indication indicating the intra-UE prioritization or the intra-UE multiplexing for the overlapping uplink channels,
wherein the uplink transmission including the one or more of the set of the overlapping uplink channels is based on the semi-static configuration in the RRC message and the collision resolution indication.

30. The method of claim 26, wherein the overlapping uplink channels are RRC configured or configured by downlink control information (DCI) including a collision resolution indication, the method further comprising applying a rule to perform at least one of:
receive a multiplexed transmission of the set of the overlapping uplink channels,
skip reception of at least one of the set of the overlapping uplink channels, or
receive the uplink transmission based on an additional RRC parameter.
